(19) United States
(12) Patent Application Publication
(10) Pub. No.: US 2015/0012818 A1
(43) Pub. Date: Jan. 8, 2015

(54) System and method for semantics-concise interactive visual website design

(71) Applicants: Ronny Reichmann, Milano (IT); Ana Rink, Milano (IT)

(72) Inventors: Ronny Reichmann, Milano (IT); Ana Rink, Milano (IT)

(73) Assignees: Ana Rink, Milano (IT); Ronny Reichmann, Milano (IT)

(21) Appl. No.: 13/902,924

(22) Filed: Jul. 7, 2013

(51) Int. Cl. G06F 17/22; G06F 3/0484; G06F 3/0482; G06F 3/0486

(52) U.S. Cl. CPC G06F 17/2247; G06F 3/0486; G06F 3/04842; G06F 3/0482
USPC 715/236; 715/234

(57) ABSTRACT

The present technology includes a method and a system for creating web pages without needing to write HTML and CSS manually. The interface module of the present invention displays a collection of user-definable component templates and a graphical presentation area for a document containing markup data, where the user can edit/preview an HTML document. The present technology enables the user to design the responsive layout of the HTML document by dragging-and-dropping components in a column-structure of the document layout, insert one component into the other, and adjust visually and through drag operations the CSS properties margin and padding of the components. During the above mentioned operations the column-structure is created and managed automatically according to user-interactions. Additionally, the technology described herein contemplates a method of providing the user with a supportive visual feedback during the above-mentioned operations.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### REFERENCE TO SEQUENCE LISTING, A TABLE, OR A COMPUTER PROGRAM LISTING COMPACT DISC APPENDIX

Not applicable

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to the design and implementation of responsive websites. Particularly, it relates to systems and methods for providing a web design tool interface, which allows the creation of responsive websites by dragging and dropping component templates into an HTML document and by directly and visually arranging those components in a responsive column-structure.

2. Background and Prior Art

More and more people access internet from their handheld devices and in some years small-screen devices will become the dominant form of web access (see [1] Ethan Marcotte, Responsive Web Design, 2011, A Book Apart, New York, p. 6, which is incorporated herein by reference). There is a wide range of devices with different screen sizes from which people can access the internet: Smartphones, tablets, PDAs, desktop PCs, game consoles, even computing devices integrated in cars and in fridges. However, the most of the web designers still design mainly for desktop computer screens and eventually prepare a mobile optimized version of the website in a second moment and completely apart from the codebase of the desktop version. Recently new approaches to web design emerged, for instance the “Mobile First” strategy proposes to design websites for basic mobile phones first and then enhance them for Smartphones and PCs (see [2] Luke Wroblewski, Mobile First, 2011, A Book Apart, New York, which is incorporated herein by reference). A similar strategy is responsive web design, which proposes: Rather than to create disconnected designs tailored to different devices and browsers, treat them as different views of the same experience (see [1] Ethan Marcotte, Responsive Web Design, 2011, A Book Apart, New York, p. 8, which is incorporated herein by reference). The characteristics and advantages of this approach are discussed below.

Responsive web design is a web design approach aimed at crafting websites that are optimally viewable on a variety of devices. Responsive design consists in applying a virtual column-grid to the layout of the website, where the width of the single column depends on the device screen width. The main advantage of responsive design is the possibility to create a flexible layout which adapts automatically to different screen widths on different devices instead of designing specifically for a fixed number of screen sizes. Another benefit of this approach is the reduction of maintenance costs, because instead of developing and maintaining separate versions of a website or website templates (in case dynamic website-serving is used) for different client devices, only a single version has to be created and maintained.

The client-based website design tools (which use the WYSIWYG [What You See Is What You Get] interaction scheme) currently present on the market don't ease the process of web design significantly (especially not when it comes to responsive designs). Most of them are based on absolute positioning of the layout elements, which represent an interaction-scheme well known by designers from applications of the field of Desk-Top-Publishing (DTP). Those print-design layouting techniques do not at all consider the fluid nature of websites. As a result mentioned DTP-like tools face considerable technical challenges in producing websites with a high quality of machine-readability. Which is in turn needed in the internet when search-engine crawlers (like Google) scan and categorize a website for it's contents.

An additional aspect has to be considered as follows: The elements inside an HTML document are actually made for different screen widths and automatic adaption to them. They are not intended to be used in means of statical and absolute positioning. The resulting HTML documents—those DTP-like tools produce—are therefore not only reduced in technical ability. But also the way the user interacts with those elements (inside said DTP-like tools) is highly inadequate and misleading. It teaches the designer to perceive and handle those elements as something they are not supposed to be.

The current state of the web design is also framed by the difficulties that result from the needed mindset of a developer and designer in one person. Traditionally HTML documents need to be written by developers by hand, in order to fulfill the capabilities of the medium. But developers more often as helpful lack design-skills. So the resulting designs are either unappealing—when written by a developer—or inappropriate in execution and maintainability—when done by a designer. As the only solution to the problem, an expensive workflow of division of labor evolved over time.

There are a few web-based web design tools, for instance: Jetstrap (see [3] Jetstrap—The Bootstrap Interface Builder, http://www.jetstrap.com/, Accessed: May. 6, 2013, which is incorporated herein by reference), Divshot (see [4] Divshot—Interface Builder for Web Apps, http://www.divshot.com/, Accessed: May. 6, 2013, which is incorporated herein by reference), Easel (see [5] Easel—Web Design in Your Browser, http://www.easel.io/, Accessed: May 6, 2013, which is incorporated herein by reference), Froont (see [6] Froont—Responsive web design, the visual way, http://froont.com/, Accessed: May 6, 2013, which is incorporated herein by reference), which allow to build a layout based on responsive framework library elements and preview the design on different screen sizes. However those tools don't sport the well-balanced user-interaction-methods subject to this disclosure. As well as sophisticated visual clues and interactions with the web page elements; like well executed drag-and-drop and visual adjustment-helpers. These characteristics are very important for interacting intuitively with the interface of such a tool and for layouting a web page time-efficient.

### REFERENCES

Prior art patents of the present invention include but are not limited to those described in the following references, all of which are incorporated herein by reference:

[7] U.S. Pat. No. 5,956,736 A entitled “Object-oriented editor for creating world wide web documents” describes a client-based authoring tool for creating WWW documents, but does not deal with the methods for visually designing responsive websites.

(15) [8] US patent application 20080120538 entitled “Visual web page authoring tool for multi-context web pages” describes a user interface which allows to author at least two context-dependent views of a web page and a framework for adaptation of single-source webpages to the current context, however it doesn't deal with the designing of a web page as a structure of columns, instead it describes authoring for a few predefined devices like smartphone, PDA and desktop. It talks about “enabling drag-and-drop operations” and “resizing of images and textboxes”, but doesn't deal with the visual feedback during the said operations. Another important difference between the present invention and the described patent application are the methods of absolute positioning and tables used in the latter, methods which are not applicable to responsive web design approach and go against the modern web design standards.

[9] U.S. Pat. No. 6,684,369 entitled “Web site creator using templates”, describes a software tool for building a website with the use of predefined templates, however it doesn't deal with designing responsive websites nor the details of user interaction with the interface during the design process at all.

[10] US Patent application 20120066601 entitled “Content configuration for device platforms” explains how to create and deliver digital content for presentation on different devices, however it doesn't deal with the approach of visually designing responsive websites.

[11] US Patent application US20100037168 A1 entitled “Systems and methods for webpage design” describes a system and a method for composing a webpage by dragging and dropping content widgets and mentions the snap-to-grid technique, however it mainly deals with absolute positioning method for designing overlapping content and doesn't refer to visually designing responsive websites.

[12] US Patent application 20070168930 entitled “System and method for designing and generating database-driven user interfaces that contain cascading plastic layout elements” describes a system and a method for defining at design-time and at run-time whether the controls on a web page will be based on a fluid or a fixed layout, however it doesn't deal with the process of visually designing the web page nor the feedback during that process.

[13] U.S. Pat. No. 5,867,144 entitled “Method and system for the direct manipulation of information with drag and drop operations” describes drag and drop operations with text in a word processing environment or the like by employing a mouse, however it doesn't deal with designing a responsive web page layout.

### BRIEF SUMMARY OF THE INVENTION

Introduction into Used Terminology

For making the terminology used in the following description clear, here is the explanation of some of the terms:

Components stand for snippets of HTML code, so called templates, which are visualized in a user-definable collection of components and which can be dragged and dropped into the document. When they are dropped into the document, they are rendered and therefore become a rendered markup of a component. The term is referenced interchangeably for components in the state of a template inside the components-collection, during drag operations and when inserted as rendered markup structure inside an HTML document.

Drag operations stand for the a user-interaction with the system. Under the condition a pointing device is used this means:
1. Hovering over an element with the user-interaction representing arrow-pointer
2. Picking the element by clicking on it
3. Starting to drag the element without releasing the button of the input device
4. Dropping the element by releasing the button of the input device

Aforementioned actions don't need to include physical buttons. Pointer input devices with sensor-surfaces instead of buttons (like trackpads and button-less computer-mice) exist and might handle drag operations in a specific way not mentioned here.

Another example might be the use of a touch-screen for dragging. In this case the process might be performed as follows:
1. Touching the element to be dragged
2. Dragging the finger over the touchscreen in order to move it to the desired location
3. Dropping the element by removing the finger from the touch-screen

Handle stands for a visual sign representing an area of user interaction, most notably in the context of a drag and drop operation.

The Summary

The present technology includes a method and a system for creating web pages without needing to write HTML and CSS manually. The interface module of the present invention displays a collection of user-definable component templates and a graphical presentation area for a document containing markup data, where the user can edit/preview an HTML document. The method described herein enables the user to design the responsive layout of the HTML document by interacting with the components with an input device (a mouse, a touch-screen or any other device imaginable) in a few ways described further.

One of the aspects of the method of present invention is the support of the user during the drag-and-drop operations with the components. The user can undergo the drag-and-drop operations with the components from the component collection or with the already-rendered components of the document. After the user selects and drags a component out of the components collection or from the HTML document itself and hovers with it over certain areas of the document or other components, he receives rich visual feedback which helps to select and understand the position for the insertion of the dragged component. When the component is dropped, automatic adjustments to the HTML element structure of the document are performed by the system of the present invention.

The method described herein allows furthermore to insert the components into the rendered markup of another component through a drag-and-drop operation either from the said components collection or from another position in the document. Like with the previous interaction, also during this operation the user receives supportive visual feedback, described in the detailed description of this document.

Another aspect of the present method is the visual adjustment of the CSS properties that are used very often during the layout process of HTML documents—margin and padding—without the need to find the correct means of CSS reference (CSS selector) and adjust the numeric values manually. The user can adjust said values through visual clues and dragging-interactions.

During the above mentioned operations the column-structure is created and managed automatically and in a WYSIWYG way according to user-interactions. Additionally, the mentioned interactions are augmented with rich supportive visual feedback that helps the user to understand the correlations of the HTML element structure he is creating.

These and other features and advantages of the present invention will become more fully apparent in the description that follows and in the claims.

### BRIEF DESCRIPTION OF THE SEVERAL VIEWS OF THE DRAWING

The figures represent examples that describe chronological interaction-processes, not static systems. The present invention is illustrated by way of example and not limitation in the following drawings:

FIG. 1A illustrates the initial state before an exemplary user-interaction for inserting a component in a document.

FIG. 1B illustrates an exemplary user-interaction represented as the on-screen-representation of a pointing-device (exemplary but not exclusively, it can also stand for a touch-interaction at the specific location) hovering over a component.

FIG. 1C illustrates the start of a drag-gesture after the representation of user-interaction (pointing-arrow) picked the component, subsequent to the state in FIG. 1B.

FIG. 1D illustrates the indication of an insertion-position during a drag-gesture, subsequent to the state in FIG. 10.

FIG. 1E illustrates the result of concluding the drag-gesture by dropping the component into the document, subsequent to the state in FIG. 1D.

FIG. 2A illustrates the initial state before an exemplary insertion of a component in a non-empty document.

FIG. 2B illustrates the start of a drag-gesture after the representation of user-interaction (pointing-arrow) picked a component, subsequent to the state in FIG. 2A.

FIG. 2C illustrates the indication of an insertion-position during a drag-gesture targeting a non-empty document, subsequent to the state in FIG. 2B.

FIG. 2D illustrates the exemplary indication of an insertion-position during a drag-gesture by hovering to the left of a rendered markup of a component.

FIG. 2E illustrates the exemplary indication of an insertion-position during a drag-gesture by hovering to the right of a rendered markup of a component.

FIG. 2F illustrates the exemplary indication of an insertion-position during a drag-gesture by hovering atop a rendered markup of a component.

FIG. 2G illustrates the exemplary indication of an insertion-position during a drag-gesture by hovering below a rendered markup of a component.

FIG. 2H illustrates the state after the drag-gesture was concluded by dropping the component to the right of a rendered markup of a component, subsequent to the state in FIG. 2E.

FIG. 3A illustrates the initial state before an exemplary insert of a component in a document that already contains rendered markup of several components.

FIG. 3B illustrates the indication of an insertion position (during a drag-gesture) in the document flow successively to the already contained markup of several components, subsequent to the state in FIG. 3A.

FIG. 3C illustrates all possible exemplary indications for inserting positions during a drag-gesture in an exploded view.

FIG. 3D illustrates the state after an exemplary drop of the dragged component atop the rendered markup of several other components.

FIG. 3E illustrates the state after an exemplary drop of the dragged component to the left of the rendered markup of several other components.

FIG. 3F illustrates the state after an exemplary drop of the dragged component in between the rendered markup of other components.

FIG. 3G illustrates the state after an exemplary drop of the dragged component to the right of the rendered markup of several other components.

FIG. 3H illustrates the state after an exemplary drop of the dragged component atop of the rendered markup of the leftmost component.

FIG. 3I illustrates the state after an exemplary drop of the dragged component atop of the rendered markup of the rightmost component.

FIG. 3J illustrates the state after an exemplary drop of the dragged component below the rendered markup of the leftmost component.

FIG. 3K illustrates the state after an exemplary drop of the dragged component below the rendered markup of the rightmost component.

FIG. 3L illustrates the state after an exemplary drop of the dragged component below the rendered markup of several other components.

FIG. 4A illustrates the initial state before an exemplary insert of a component into the already rendered markup of another component.

FIG. 4B illustrates the start of a drag-gesture for the purpose of inserting the dragged component, subsequent to the state in FIG. 4A.

FIG. 4C illustrates a sign indicating an insertion-region appearing while hovering over the rendered markup of another component, subsequent to the state in FIG. 4B.

FIG. 4D illustrates the hovering over the sign indication of an insertion-region, subsequent to the state in FIG. 4C.

FIG. 4E illustrates the emphasis of a component opened after a time delay, subsequent to the state in FIG. 4D.

FIG. 4F illustrates the result of dropping the dragged component into another component, subsequent to the state in FIG. 4E.

FIG. 5A illustrates the initial state of an exemplary change performance of the margin of a component.

FIG. 5B illustrates the exemplary emphasis of a component with the handles for performing margin changes in several directions.

FIG. 5C illustrates the initial state of an exemplary margin change performance concerning the top value of said margin.

FIG. 5D illustrates the result of performing a change to the top value of the margin, subsequent to the state in FIG. 5C.

FIG. 5E illustrates the initial state of an exemplary margin change performance concerning the right value of said margin.

FIG. 5F illustrates the result of performing a change to the right value of the margin, subsequent to the state in FIG. 5E.

FIG. 6A illustrates the exemplary emphasis of a component with handles for performing padding changes in several directions.

FIG. 6B illustrates the initial state of an exemplary padding change performance concerning the left value of said padding.

FIG. 6C illustrates the result of performing a padding change to the left value of said padding, subsequent to the state in FIG. 6B.

### DETAILED DESCRIPTION OF THE INVENTION

Introduction

Various embodiments of the disclosure are described in detail below. While specific exemplary implementations are discussed, it should be understood that this is done for illustration purposes only. A person skilled in the relevant art will recognize that other configurations and implementations may be used without parting from the main scope of the disclosure.

The present disclosure addresses the need of a tool which enables web designers and developers to design websites visually without needing to write HTML and CSS manually.

The Column Layout

The positioning of the components in relation to each other works without explicit layout managers. The components can be positioned atop/below/next-to/between/inside one another by means of user-interaction with a rich visual feedback. The column-structure is adjusted automatically and in a WYSIWYG way according to the positions components are inserted/dropped in relation to one another. For example, when a component is dropped horizontally next to another component, another column is created automatically, restricting the widths of the components next to each other, forming an equally-sized distribution.

Drag-and-Drop Operations with Components

One of the aspects of the interaction method of the present invention is the support of the user during the drag-and-drop operations with the components.

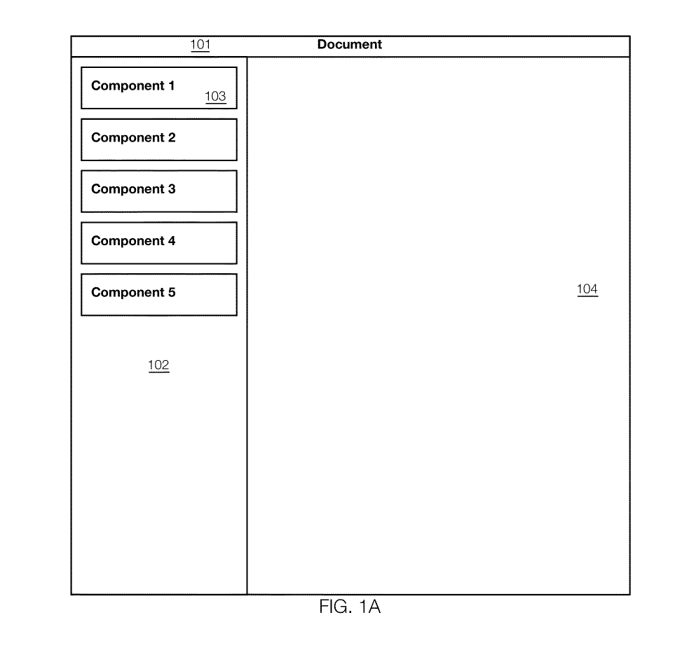

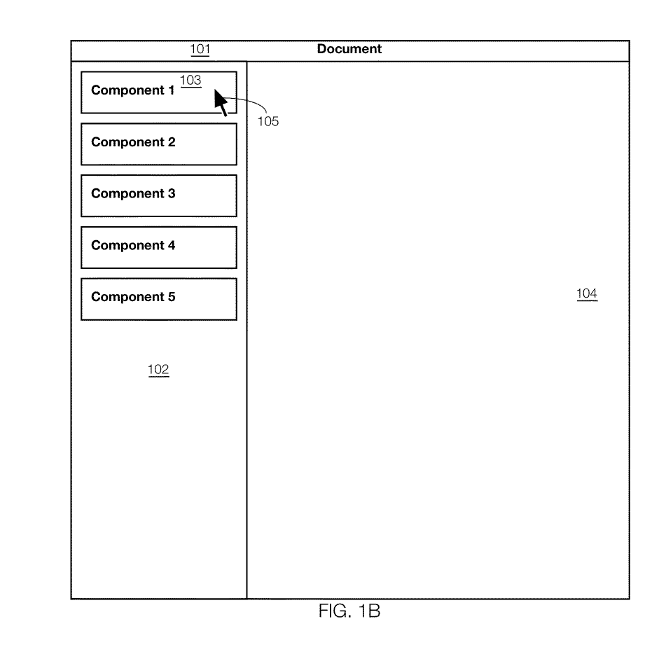

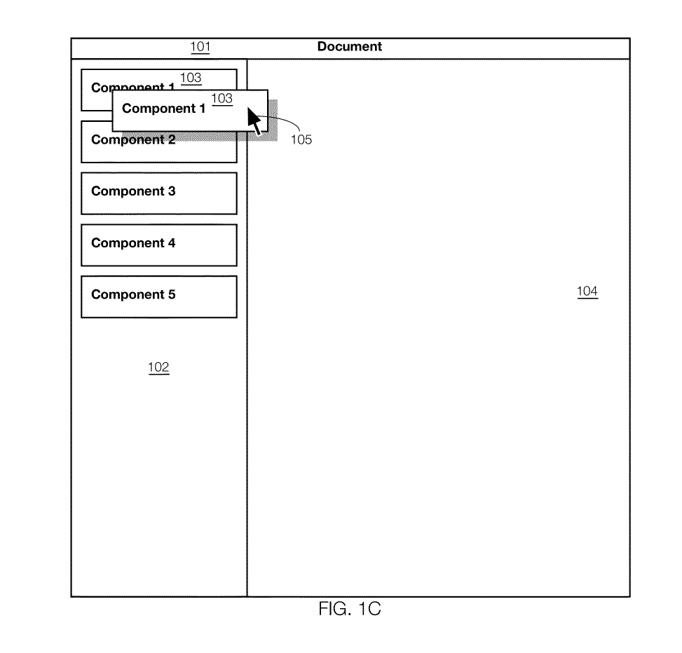

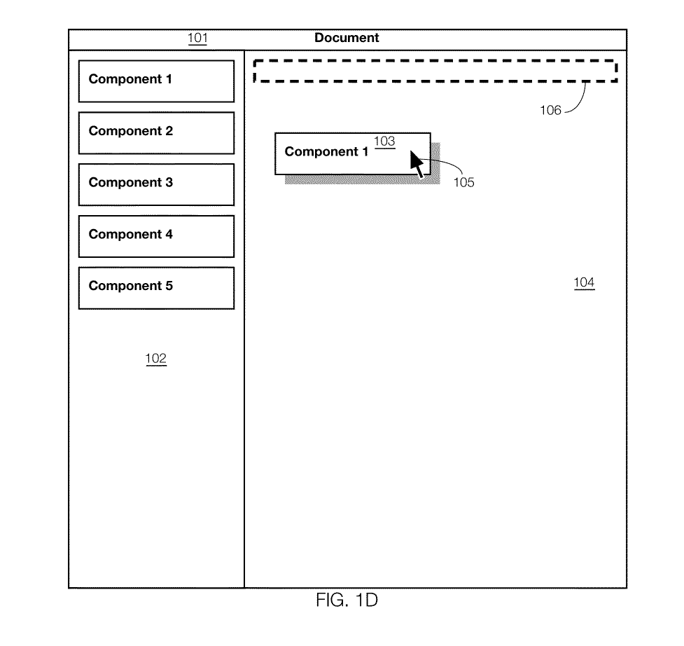

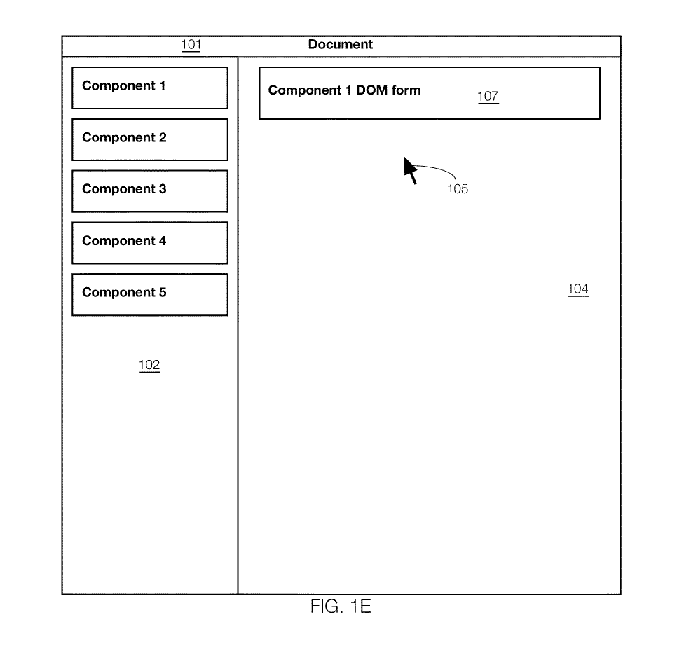

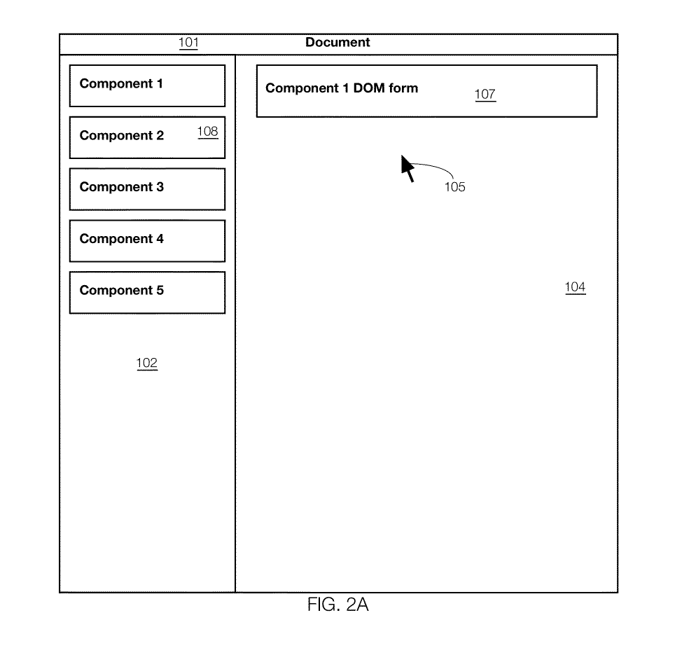

For enabling an intuitive interaction with the documents column structure, visual feedback is provided, which occurs in the moment of the drag-and-drop operation. One of the exemplary embodiments of such visual feedback is illustrated in the FIGS. 1A-1E, each standing for a chronological step of the exemplary interaction with a component in an initially empty document.

FIG. 1A illustrates the area of the display device (exemplary but not exclusively: window), which's title is 101 containing the graphical representation of a collection (exemplary but not exclusively: list) of component templates 102 of which 103 is one entity. It is accompanied by a graphical presentation area for a document containing markup data 104 (HTML) in it's initial state, right before an exemplary user interaction takes place. The shown orientation of the collection of components 102 towards the area presenting the document 104 is exemplary only. Other spacial relations are imaginable. The user can undergo the drag-and-drop operations with the components from the component collection list 102 or with the components already inserted inserted in the document 104. In the present figure the document is empty.

The user undergoes the following exemplary steps:

Step 1. Hovering over a component. FIG. 1B illustrates an exemplary user interaction, as an on-screen-representation of a pointing-device 105 (in this case it's a mouse-pointer, however in other possible embodiments it can also stand for a touch-interaction at the specific location) is hovering over a component 103.

Step 2. Picking a component. FIG. 1C illustrates the start of a drag-gesture after the representation of user-interaction (pointing-arrow) 105 picked the component 103.

Step 3. Indication of the insertion position. FIG. 1D illustrates how the user is dragging the component 103 over the document 104. In the present exemplary embodiment the computer system draws an insertion-indication 106 at the possible position during the drag-operation, which under the condition of the exemplary empty document is always the first position, no matter where exactly inside the document the user will drop the component.

Step 4. Dropping the component. FIG. 1E illustrates the result of concluding the drag-gesture by dropping the component into the document. The dropped component 107 is rendered and becomes part of the DOM (document object model) structure of the document.

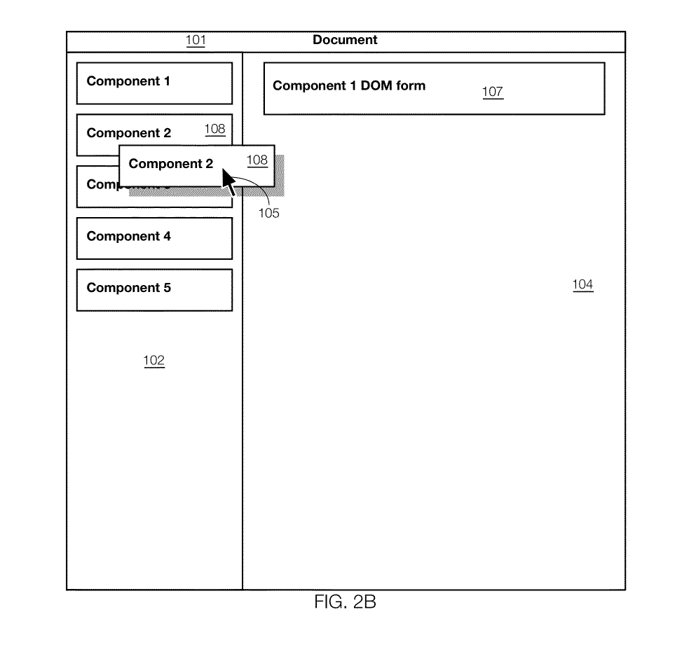

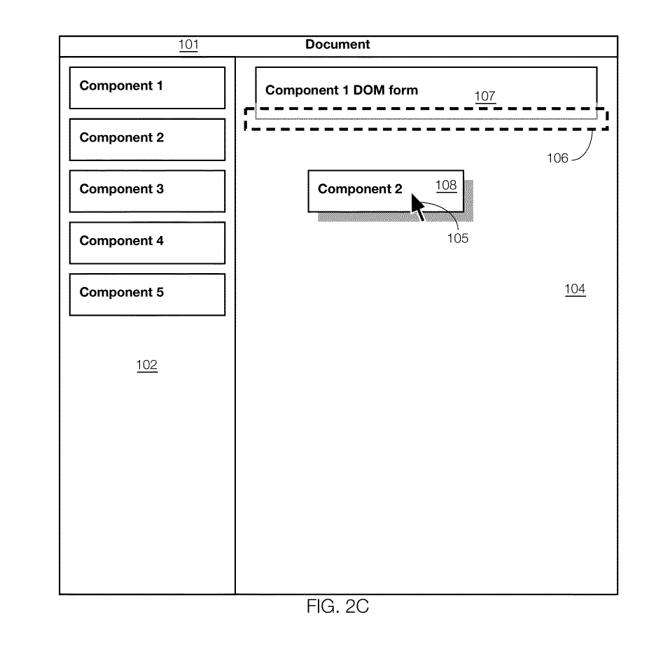

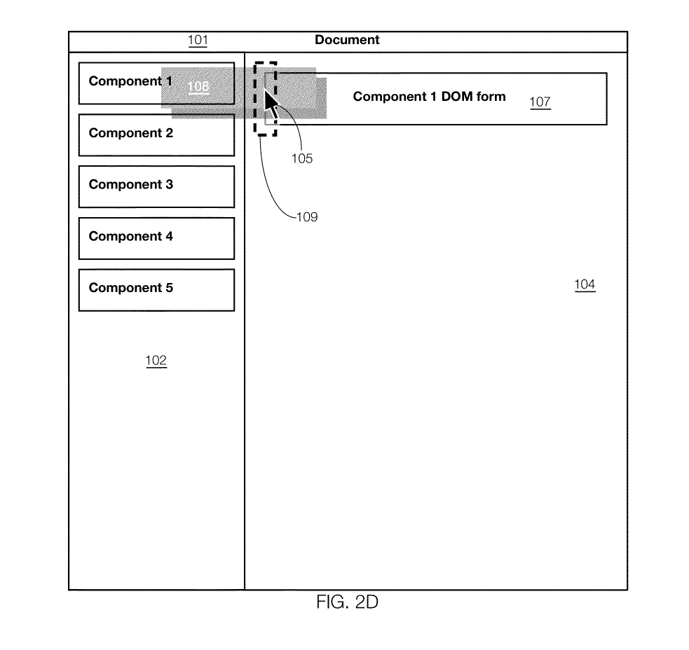

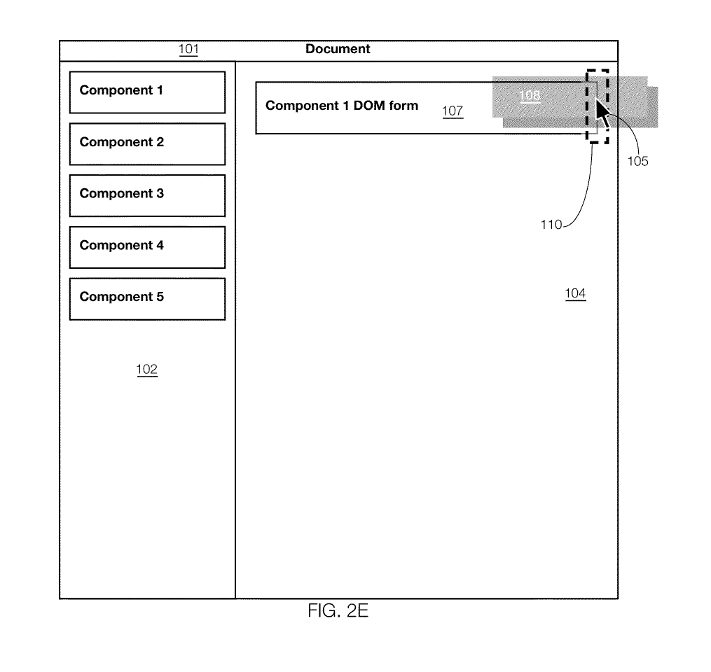

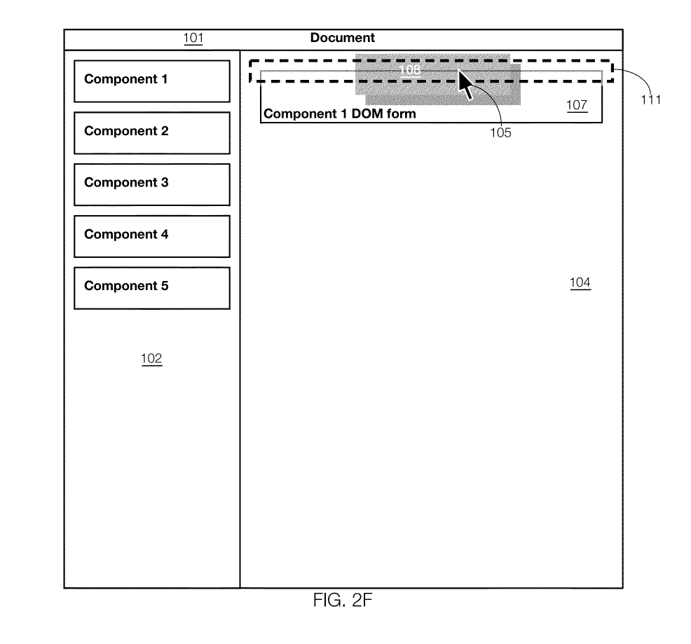

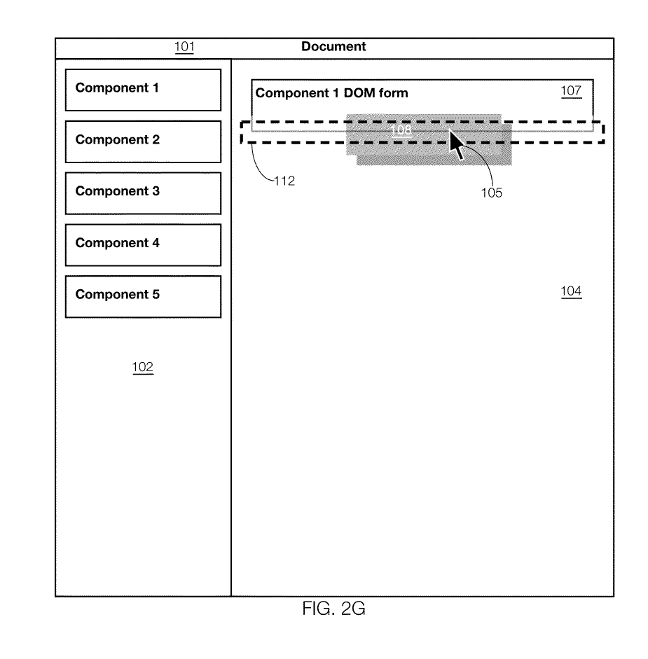

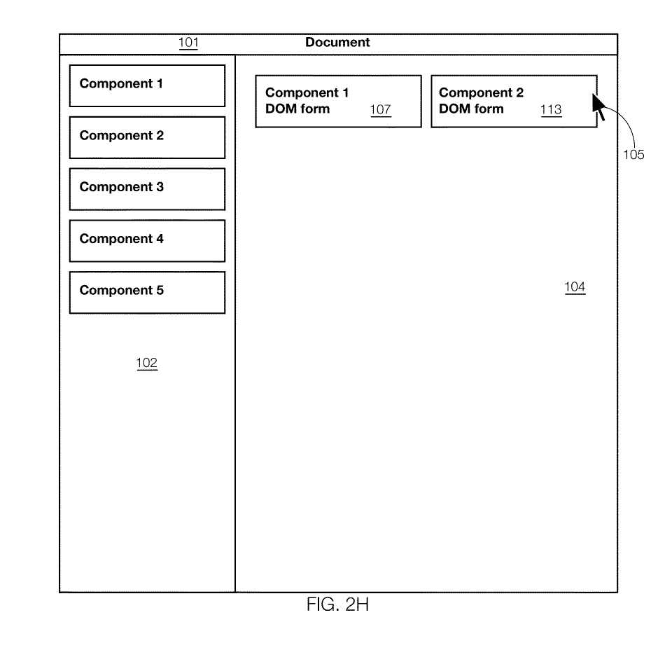

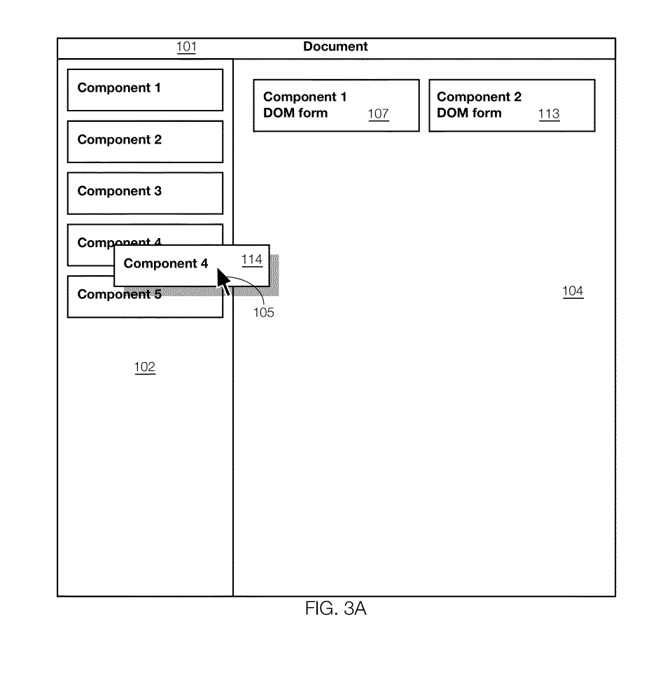

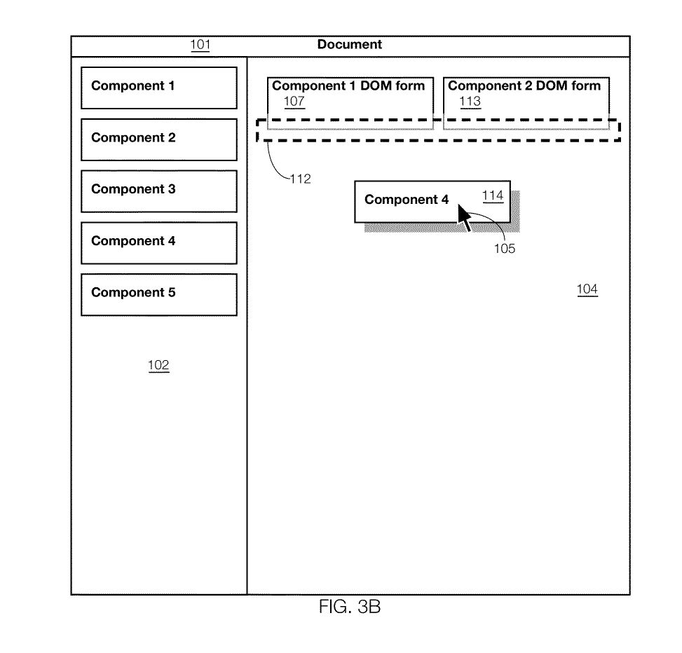

For making further aspects of the interaction method of the present invention apparent, an exemplary interaction with a component in a non-empty document is illustrated in the FIGS. 2A-2H. In this embodiment of the interaction the user undergoes the following exemplary steps:

Step 1. Initial state of a non-empty document. FIG. 2A illustrates the initial state before inserting a component in a non-empty document, where the document contains one rendered component 107. Which occupies the whole width of the document.

Step 2. Hovering over a component. This action doesn't require an illustration as it is identical to the action described in the FIG. 1B.

Step 3. Picking a component. FIG. 2B illustrates the start of a drag-gesture after the representation of user-interaction (pointing-arrow 105) picked the second component 108 from the list of components. If there were more than one element in the document, the present exemplary interaction would be also possible with a component taken from the contents of the document.

Step 4. Indication of the insertion position at the nearest possible point in the document flow. FIG. 2C illustrates the indication of an insertion-position during the drag-gesture, where the user is hovering with the dragged component 108 over the document 104, in an arbitrary position, not too close to the first component 107. In the present embodiment the computer system draws an exemplary insertion-indication 106 for indicating the nearest possible insertion position (nearest to the hovering position of the pointing-arrow 105) during said operation.

Step 5. Indication of the insertion position to the left of the first component.

Another possible insertion position in this example to the left of the first component 107, which is illustrated in FIG. 2D, where the user hovers with the second component 108 (the illustration of the dragged component 108 is greyscale and transparent only, for making the underlaying illustrations visible) to the left of the first component 107 and accordingly the insertion-indication 109 is drawn to the left of the first component 107.

Step 6. Indication of the insertion position to the right of the first component. The third possible insertion position is to the right of the first component 107, this example is illustrated in FIG. 2E. The user is hovering with the second component 108 to the right of the first component 107 and accordingly the insertion-indication 110 appears to the right of the first component 107.

Step 7. Indication of the insertion position atop the first component. The fourth possible insertion position is atop the first component 107, this case is shown in the FIG. 2F. The user is hovering with the second component 108 atop the first component 107 and accordingly the insertion-indication 111 appears atop the first component 107.

Step 8. Indication of the insertion position below the first component. Another possible insertion position is below the first component 107, this case is illustrated in the FIG. 2G. The user is hovering with the second component 108 below the first component 107 and accordingly the insertion-indication 112 appears below the first component 107. The result of the insertion would be the same like in the figure FIG. 2C, only the hovering position of the dragged component is different.

Step 9. Dropping the component. FIG. 2H illustrates the state after the drag-gesture was concluded by dropping the component 108 to the right of the first component 107. The component 108 is rendered and becomes part of a column structure of the HTML document, by that turning into the rendered form of a component 113. An HTML column structure is created and adjusted automatically, resulting in 2 equally-sized columns.

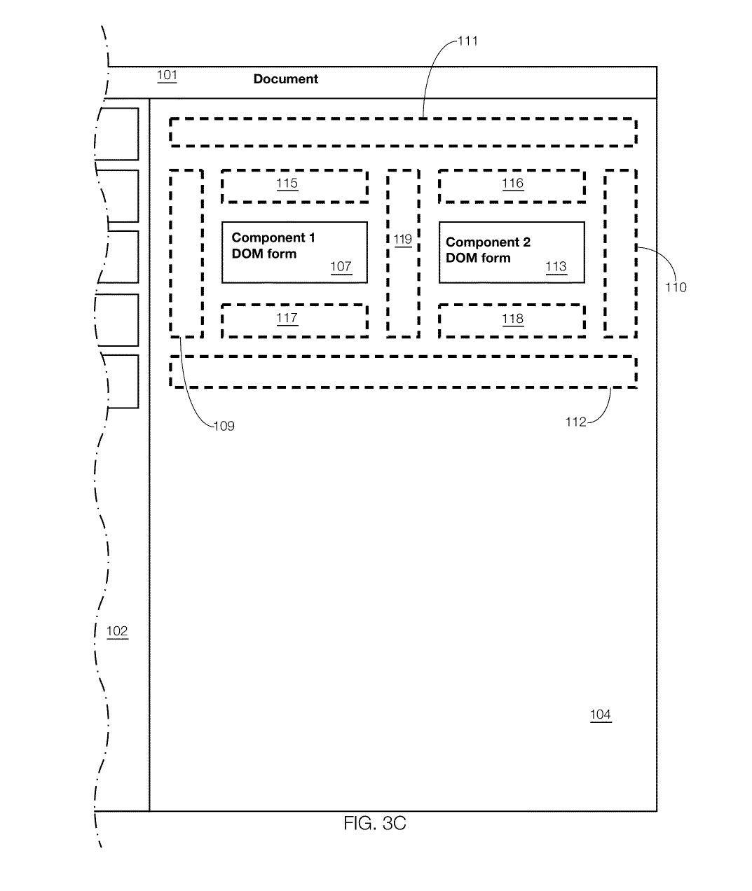

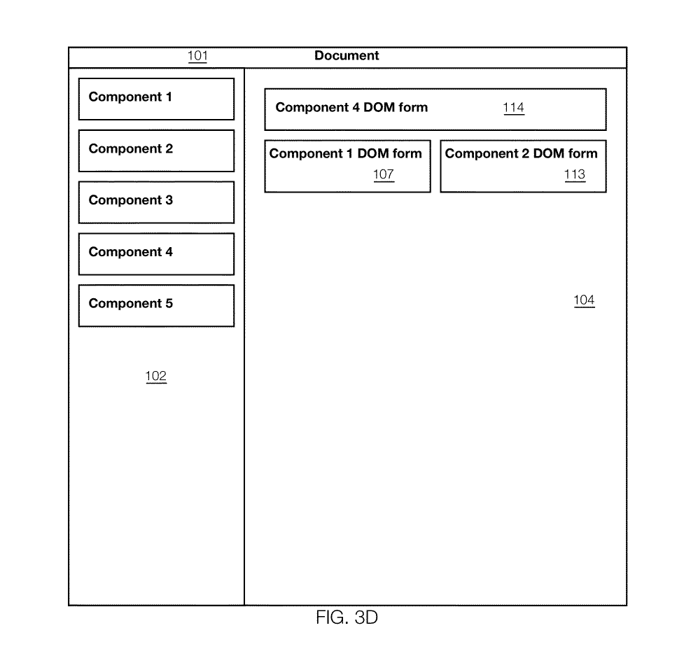

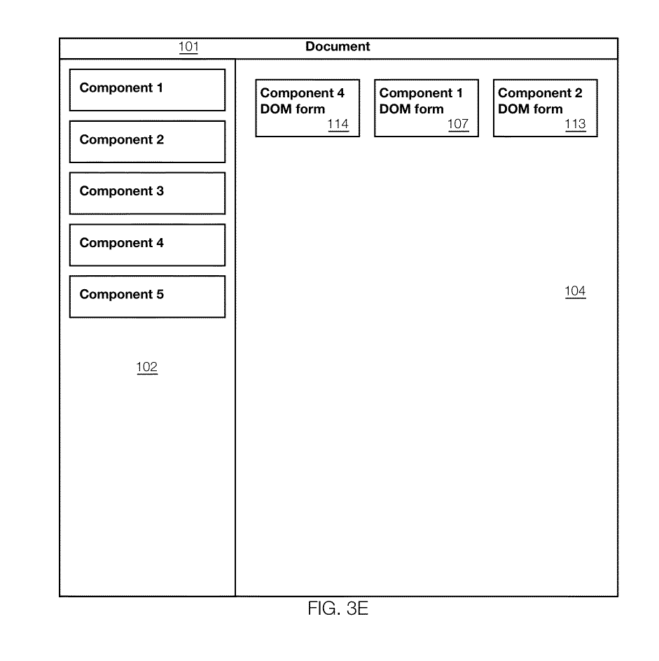

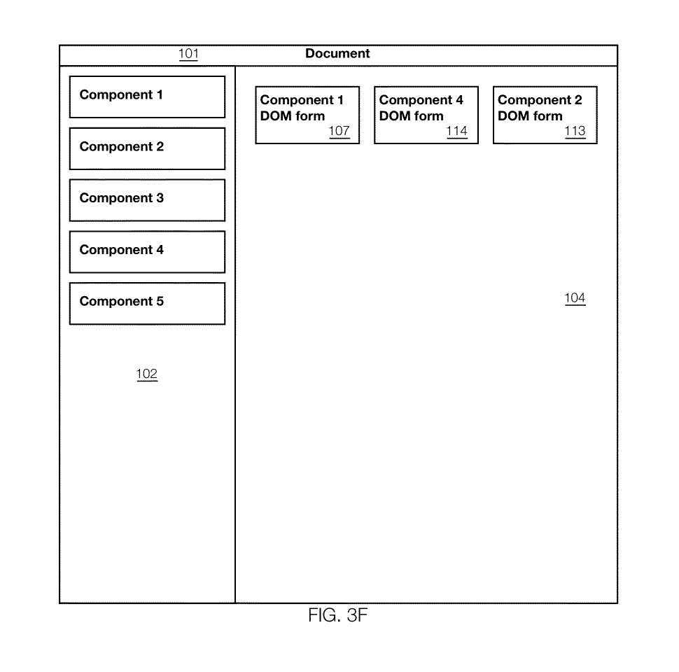

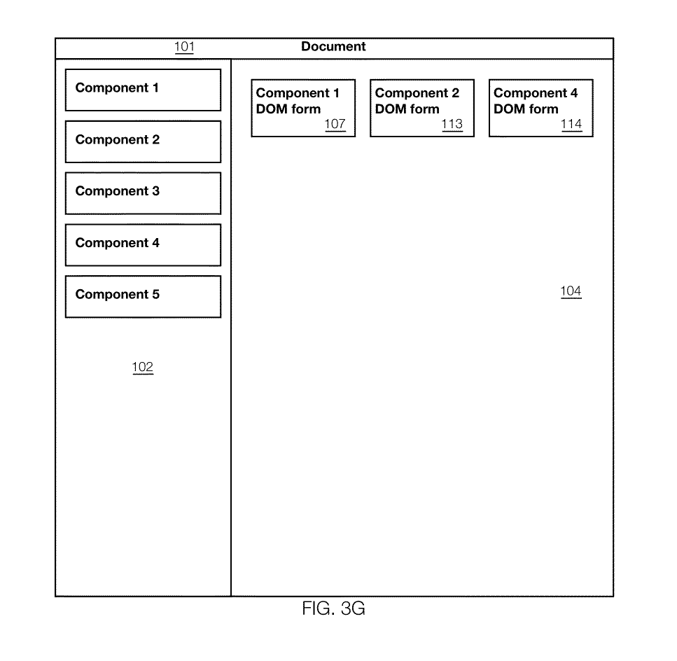

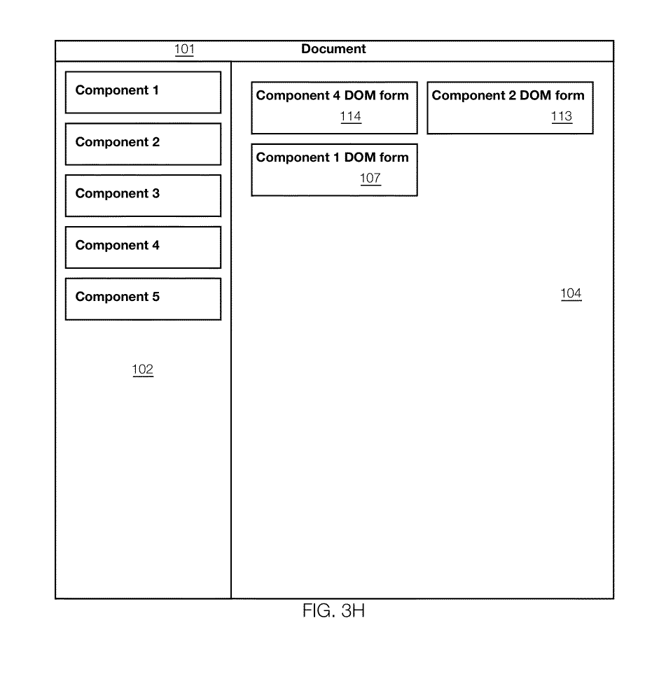

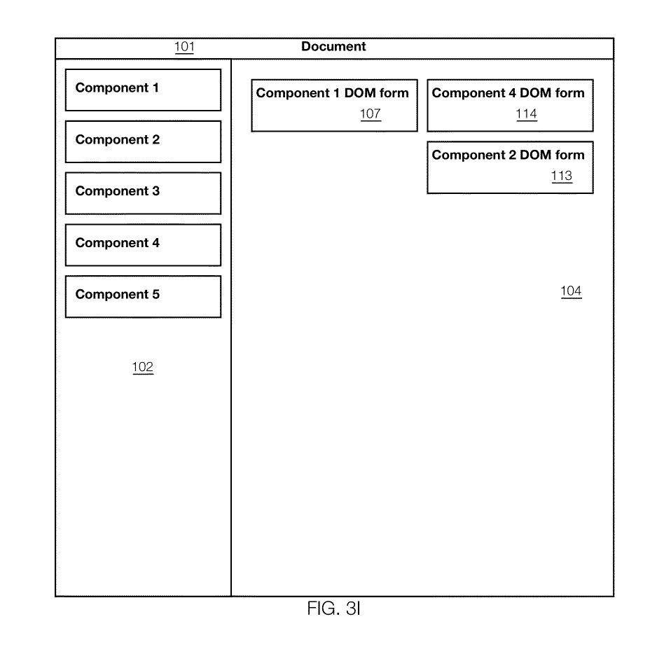

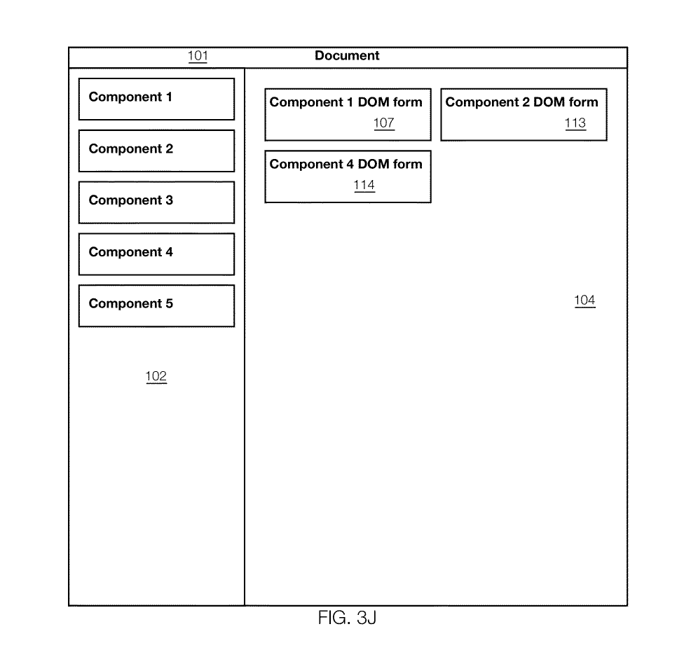

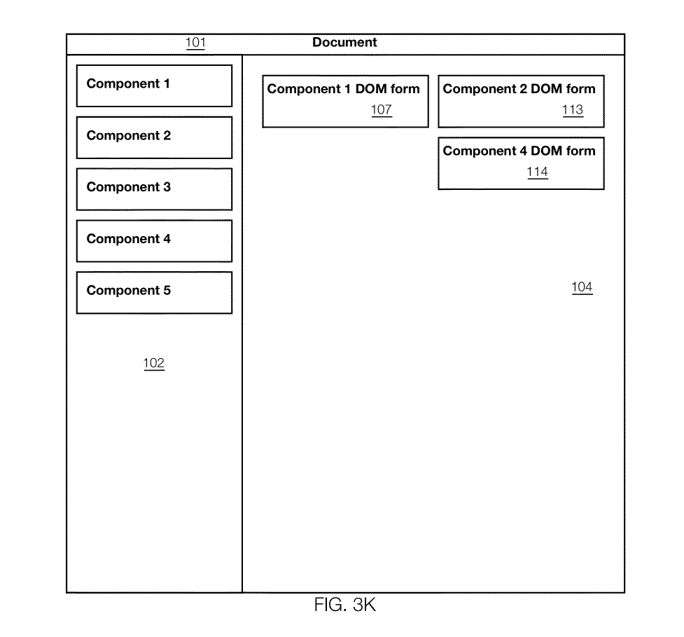

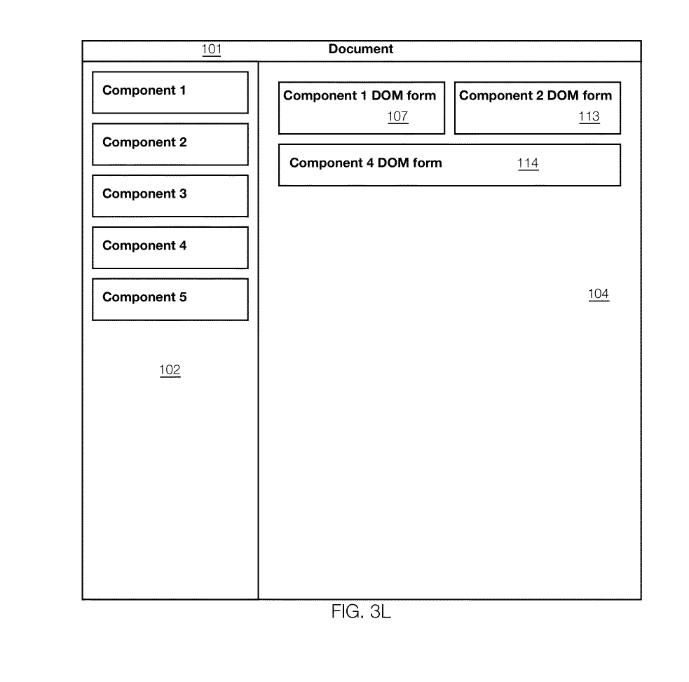

For making all aspects of the interaction method of the present invention apparent, an exemplary interaction with a few components in a document is illustrated in the FIGS. 3A-3L.

FIG. 3A illustrates the initial state before inserting a component 114 in a document that already contains rendered markup of several components—first component 107 and second component 113.

FIG. 3B illustrates the indication of the nearest possible insertion position 112 (during a drag-gesture) in the document flow successively to the already contained markup of several components (components 107 and 113).

FIG. 3C illustrates all possible indications for insertion positions during a drag-gesture in an exploded view. The position of the insertion indication depends upon the location the dragged component is hovering over a component in the document. On drop, the component being dragged will be inserted at the position that was indicated during the drag-operation. The possible positions illustrated around the already present components 107 and 113 in FIG. 3C are as follows:

Position 111—indicates insertion of a component atop a column structure preceding it in the element flow of the HTML document. The result of this action is illustrated in FIG. 3D, where the component 114 was placed atop the other two components.

Position 110—indicates insertion of a component inside a new column to the right of an existing column structure in the HTML document. The result of this action is illustrated in FIG. 3G, where the component 114 occupies the position to the right of other two components.

Position 112—indicates insertion of a component below a column structure succeeding it in the element flow of the HTML document. The result of this action is visible in FIG. 3L, where the component 114 got inserted below the other two components;

Position 109—indicates insertion of a component inside a new column to the left of an existing column structure in the HTML document. The result of this action is illustrated in FIG. 3E, where the component 114 occupied the position left to the other two components;

Position 119—indicates insertion of a component inside a new column between 2 existing columns in the structure of the HTML document. The result of this action is illustrated in FIG. 3F, where the component 114 is placed between the other two components;

Position 115—indicates insertion of a component inside an existing column, above another component already in the HTML document. The result of this action is visible in FIG. 3H, where the component 114 is placed in the column atop the component 107;

Position 116—indicates insertion of a component inside an existing column, above another component already in the HTML document. The result of this action is visible in FIG. 3I, where the component 114 occupied the position atop the component 113;

Position 117—indicates insertion of a component inside an existing column, below another component already in the HTML document. The result of this action is visible in FIG. 3J, where the component 114 occupied the position below the component 107;

Position 118—indicates insertion of a component inside an existing column, below another component already in the HTML document. The result of the action can be seen in FIG. 3K, where the new component 114 tool place in the position below the component 113;

The interaction examples illustrated in FIGS. 1A-3L could be expressed as different embodiments of visual feedback during the interaction with the column-structure. Another example would be that in the moment of hovering with the dragged component over the document, some free space or a dummy-representation of the dragged component is visualized where the rendered markup of a component would appear after the drop. Augmentations with different forms of highlighting or other ways of indication are imaginable.

Process Specification

Detailed insights into the actions performed during the dragging-process as represented by the present disclosure are presented as follows:

As depicted by the flow diagram in FIG. 7A, the important aspects begin after the dragging operation started 147. The system anticipates the event of a component being dragged over another component in the document 148. Thereupon calculates detailed informations upon the position of the dragged component in relation to the components and the document it is dragged over. FIG. 7A shows only a compressed version of the definition of the insertion emphasis 149, basically composed of the determination of position of the dragged component over another component in the document 150 and the possibly thereon adjacent displaying of the insertion emphasis 151.

The definition of the insertion emphasis 149 is illustrated in more detail by FIG. 7B: The decision process upon which an insertion emphasis is displayed at a specific location in the document, runs as follows: If the component can be classified to be positioned over the top edge of another component 159, the insertion emphasis will be displayed at that location 160. If not, the classification as positioned to the left edge of the underlaying component is checked for 161 and if positive the insertion emphasis will be displayed at that location 162. If not, the classification as positioned to the right edge of the underlaying component is checked for 163 and if positive the insertion emphasis will be displayed at that location 164. If not, the classification as positioned to the bottom edge of the underlaying component is checked for 165 and if positive the insertion emphasis will be displayed at that location 166. If not, no insertion emphasis is displayed and the system returns to anticipating a change in the position of the dragged component 167.

To those skilled in the art it is immediately evident, that the aforementioned exact sequence of position tests is of no importance concerning the functioning of the present invention. Therefore an embodiment might be based upon a completely different order of performing these tests.

Back at FIG. 7A the flow continues by an anticipation of a drop event 152. If this is not given the system returns to anticipating a change in position caused by moving the dragged component over another component in the document 148.

In case condition 152 is positive, the component was dropped by the user, the flow continues with the determination of the position of the just dropped component 154. Those skilled in the art will notice that a second determination of position 154 is not necessarily needed, as long as the position information computed during the first position determination run 150 can be recovered. An embodiment might therefore replace this step in the process by a retrieval of that position information. Subsequently the definition of the component insertion 153 (as depicted in compressed form in FIG. 7A) continues by the creation of a new column structure 155 (under certain conditions, as will be explained later) and concludes by the insertion of the component 156.

The definition of the component insertion 153 is illustrated in more detail by FIG. 7C: The decision process upon which a component is inserted into the document runs as follows: If the component can be classified to be dropped over the top edge of another component 169, the dropped component will be inserted preceding the component it was dropped over 170. If not, the classification as dropped to the left edge of the underlaying component is checked for 171 and if positive the component it was dropped over is checked for being inside a column structure 173. If not the component dropped over will be surrounded by a column structure 174. After assuring the presence of a column structure, a new column is created for the dropped component 176 and the dropped component is inserted therein 179. If the dropped component could not be classified to being dropped over the left edge of the underlaying component, but the right one, as expressed by condition 177, the same procedure is executed with following variation: The sub-procedure expressed inside the boundaries 172 and 175 is equal, while after assuring the presence of a column structure a new right column will be added 178 instead and the dropped component will be inserted into it 179. However, if the component can be classified to be dropped over the bottom edge of another component 180, the dropped component will be inserted succeeding the component it was dropped over 181. So far the detailed process of the definition of the content insertion finishes 182. Thereby the drag and drop process of components as illustrated back at FIG. 7A ends 157. To those skilled in the art it is immediately evident, that the aforementioned exemplary expression of the procedure for inserting a component in a document while performing an automatic handling of column structures, may be embodied by various modifications and changes to the principles specified herein.

The embodiments described above and illustrated in FIGS. 7A-7C are provided by way of example only. They should not be interpreted as a limitation of the scope of the present invention. Various modifications and changes to the example embodiments and applications described and illustrated in this writing are imaginable, without moving away from the scope and concepts expressed by the present invention.

Inserting Operations

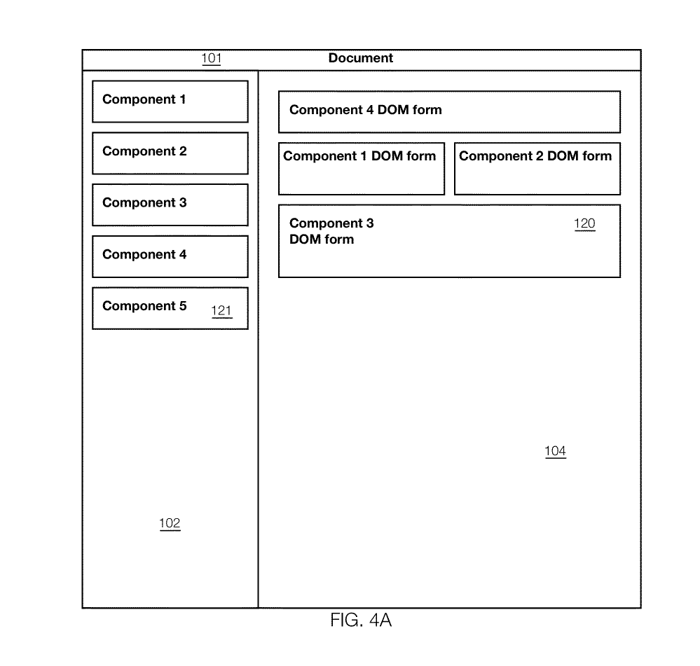

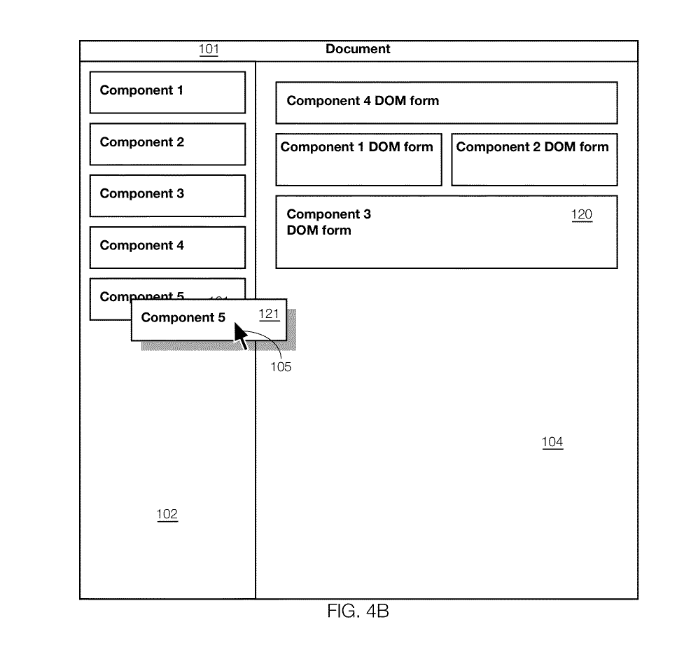

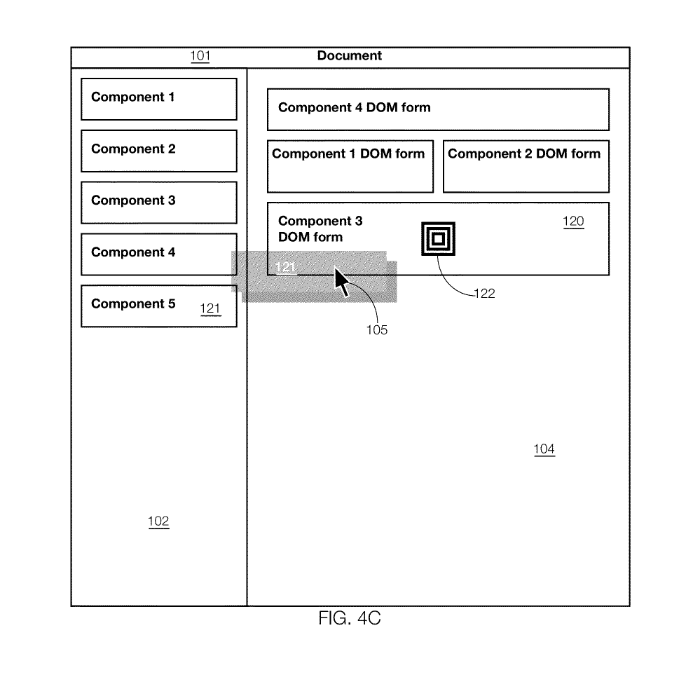

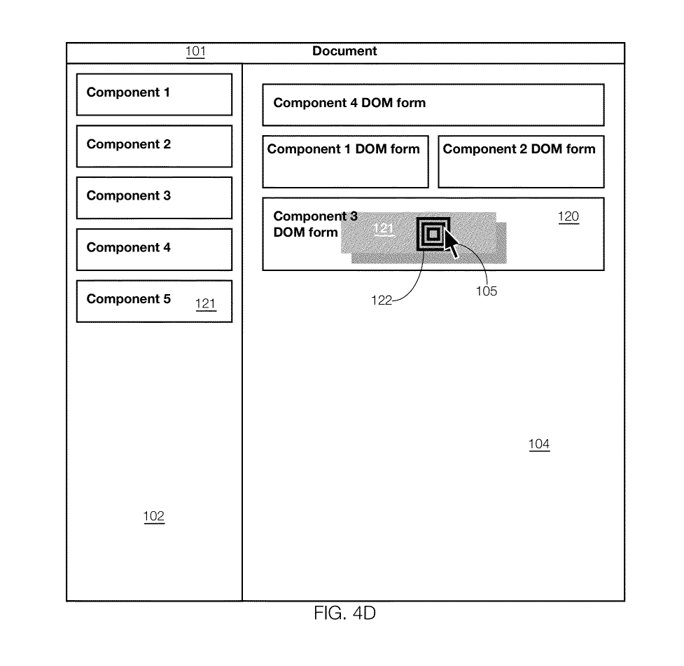

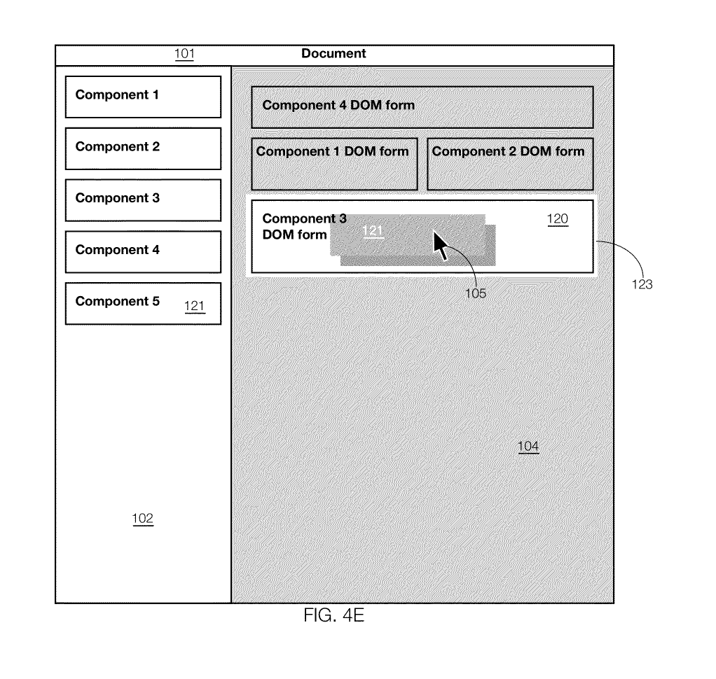

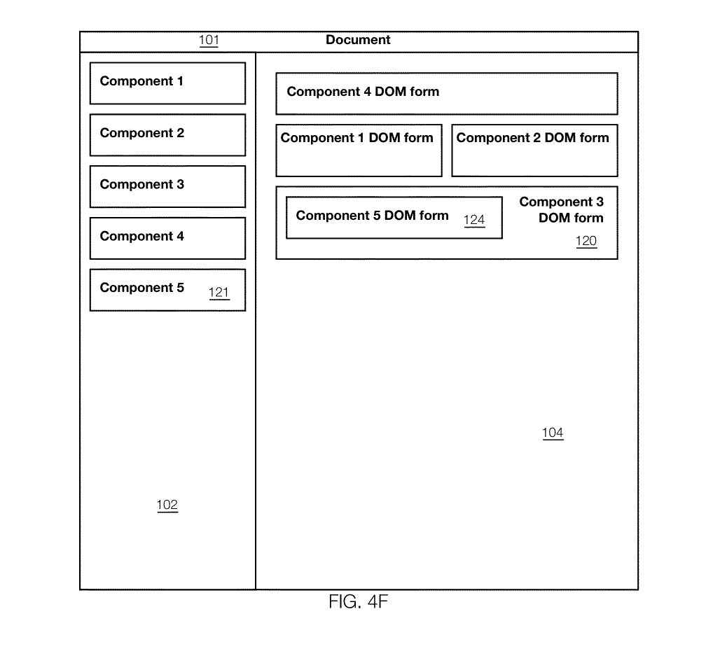

One of the features of the interaction method described in the present invention is the possibility to insert one component into another directly without the need to use further commands or steps, augmented by rich visual feedback accompanying the operation. For inserting a component into another (in some embodiments it could be the insertion of an image into a text block, an icon into a button; more generalized: a layout element into another layout element) for design or semantic grouping purposes, the user undergoes the following steps, illustrated in the FIGS. 4A-4F:

Step 1. FIG. 4A illustrates the initial state of the document, before inserting a component into the rendered markup of another component. The document already contains a few rendered components: Components 1-4.

Step 2. Start of a drag gesture, illustrated in FIG. 4B. The user-interaction 105 (pointing-arrow) picks the component 121 from the list of components for the purpose of inserting it into the already rendered markup, the component 120.

Step 3. Indication of insertion possibility, illustrated in FIG. 4C. The user-interaction 105 (pointing-arrow) is hovering over the rendered markup of the target component 120. The dragged component 121 is illustrated in greyscale and transparent only for illustration purposes, for making the underlaying illustrations visible. During this operation a sign 122 indicating an insertion-region appears. This step is useful not only for giving feedback to the user about the possible insertion operation, it is also useful for distinguishing the components where the insertion operation is possible from the components where it is not.

Step 4. Hovering over delay, illustrated in FIG. 4D. The user-interaction 105 (pointing-arrow) hovers for a specific amount of time over the intended target component 120, not leaving the sign of the insertion-region 122.

Step 5. Emphasis of the insertion-mode of the target component 120, illustrated in FIG. 4E. After the specific amount of time mentioned in the previous step 4 (illustrated in FIG. 4D) elapsed, the target component 120 is switching into insertion-mode (“opened” for insertion), accepting the insertion of the dragged component. This state change is represented by the emphasis 123 of the target component 120. In some embodiments it could get highlighted, while the rest of the scene would get obscured. In some embodiments the target component could get surrounded by an emphasizing frame, or be highlighted in another way imaginable.

Step 6. The result of dropping the dragged component, illustrated in FIG. 4F.

The dragged component is dropped into the target component 120 and gets rendered as markup 124.

The step 5 of the example described above—as illustrated in FIG. 4E—comprises the possibility to refine the exact position of the dragged component—with intermediate steps—down to character/text level. Due to the fact that a complex layout can consist out of a number of nested column structures, the procedure described above in steps 1 to 5 can be repeated until the user reaches the exact nested column-structure, that he intends to insert the dragged component into. At this point the procedures concerning the insertion of components next to each other (to the top, right, bottom, left or between 2 other components) apply as described in a former section of the present disclosure. If instead a component does not contain a nested column structure and this component contains text—which is the case with all components of typographic sort—this component is opened in text editing mode. In this text editing mode the insertion follows the computing platforms standard rules for inserting content inside a text: For example the text-insertion-cursor follows the position of the user interaction, still holding the dragged component. Dropping the component thereafter inserts it at the specified position inside the flow of the text of the opened component. However the exact process of text insertion is not part of the present disclosure. The only aspect to be noted is that a component not containing a nested column structure (with other components) is opened in a text editing mode, that supports dropping of components in the standard way, supported by the computing platform implementing the present invention.

One of the tools mentioned in the Background and Prior Art section, Froont (see [6] Froont—Responsive web design, the visual way, http://froont.com/, Accessed: May 6, 2013, which is incorporated herein by reference), allows to drag-and-drop an element into another and provides a visual feedback during the insertion operation, and therefore might appear as prior art of the former aspect of the present invention. However the mentioned functionality doesn't contain the same refined insertion interactions like the one described above. Instead it stops at the point of presenting a sign of insertion to the user as a sole means for indicating that he is about to insert an element into another. The aspects of delayed opening (level-based on nested columns structures) are not present in the aforementioned tool.

The previous description is only an exemplary embodiment of the interaction method of the present invention and should not be seen as a limitation. The specific forms and styles of illustrative elements can vary in different embodiments of this invention:

The way the insertion region gets represented, for instance it could be represented by a special highlighting of the component, by a frame or another visual effect;

The form and position of the insertion sign 122 (FIG. 4C);

The time delay when the user hovers over the target component before the target component switches into insert-mode (“opening”) and is ready for accepting the dragged component;

The way in which the dragged component gets placed into the target component and the visual effects accompanying this operation.

Adjustment of CSS Properties—Margin and Padding

Another feature of the tool described in the present invention is the possibility to adjust the CSS properties—Margin and Padding—of a component visually, through a drag operation. For adjusting margin values the user undergoes the following steps:

The action starts by switching into the editing mode for margins through a menu item, a shortcut or by pressing a toolbar button. Other embodiments of switching into aforementioned editing mode are possible.

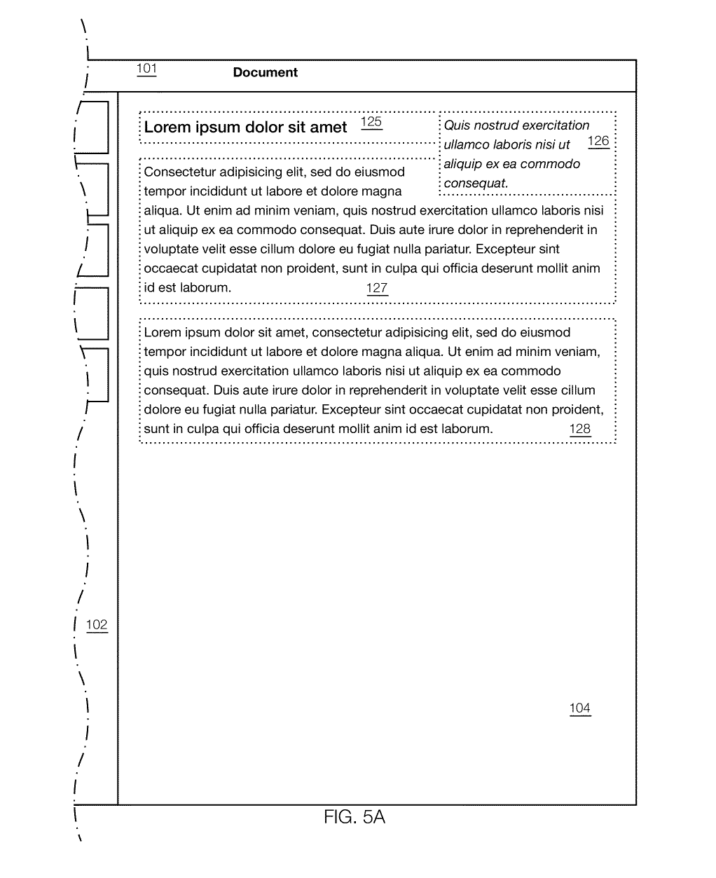

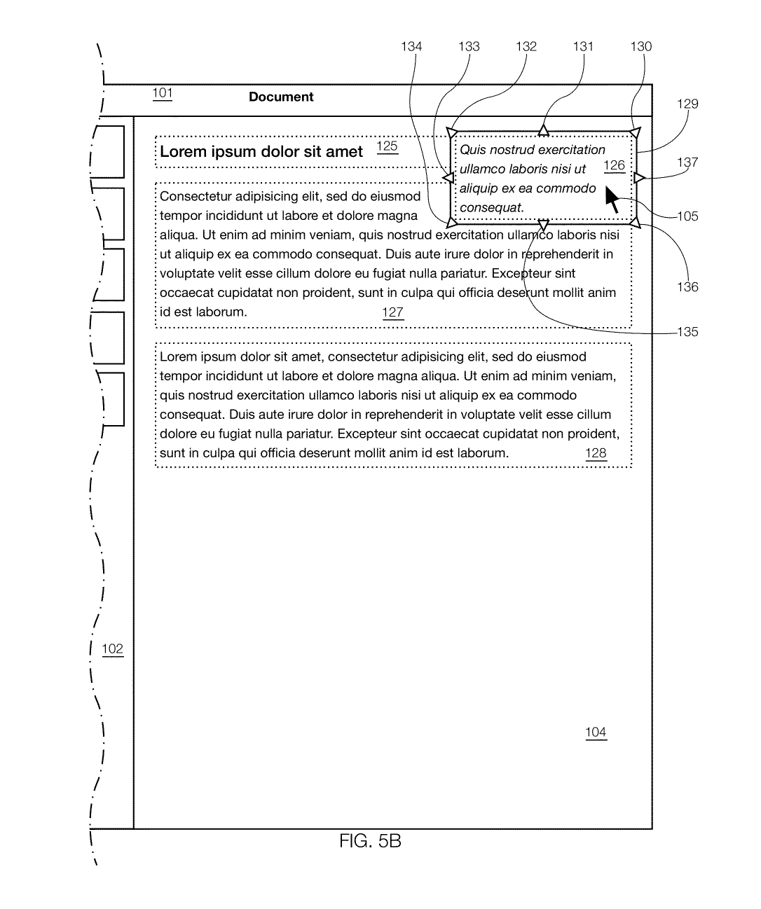

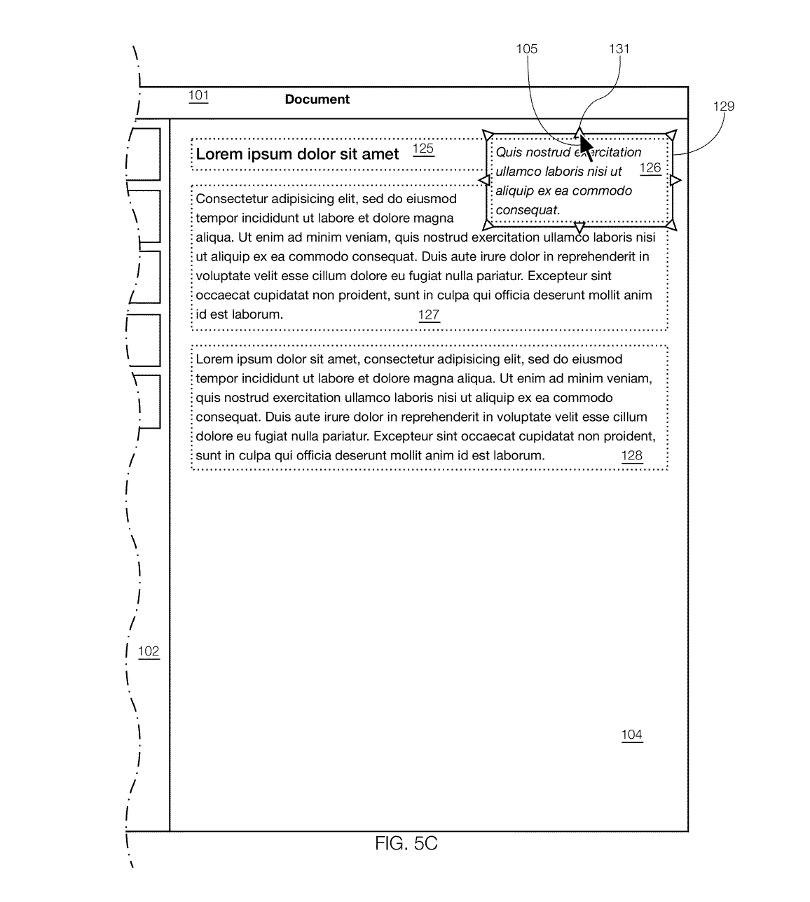

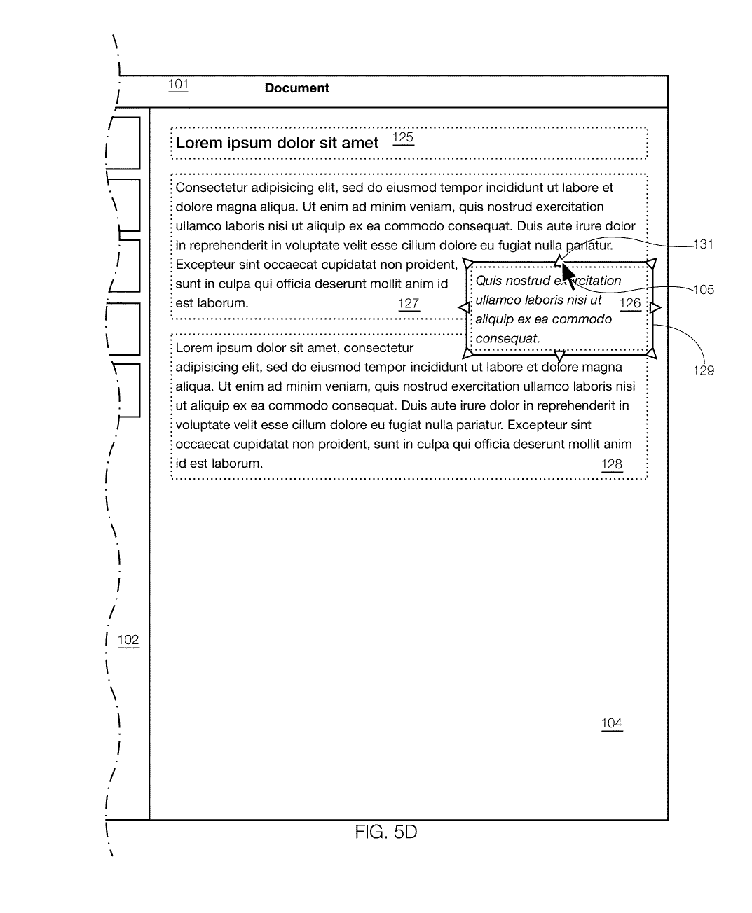

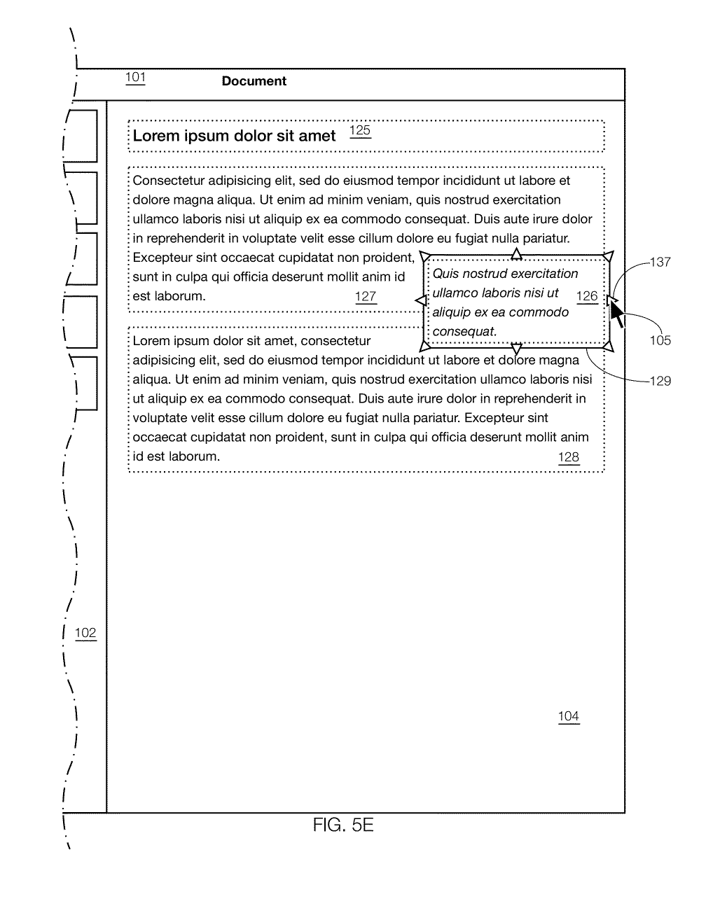

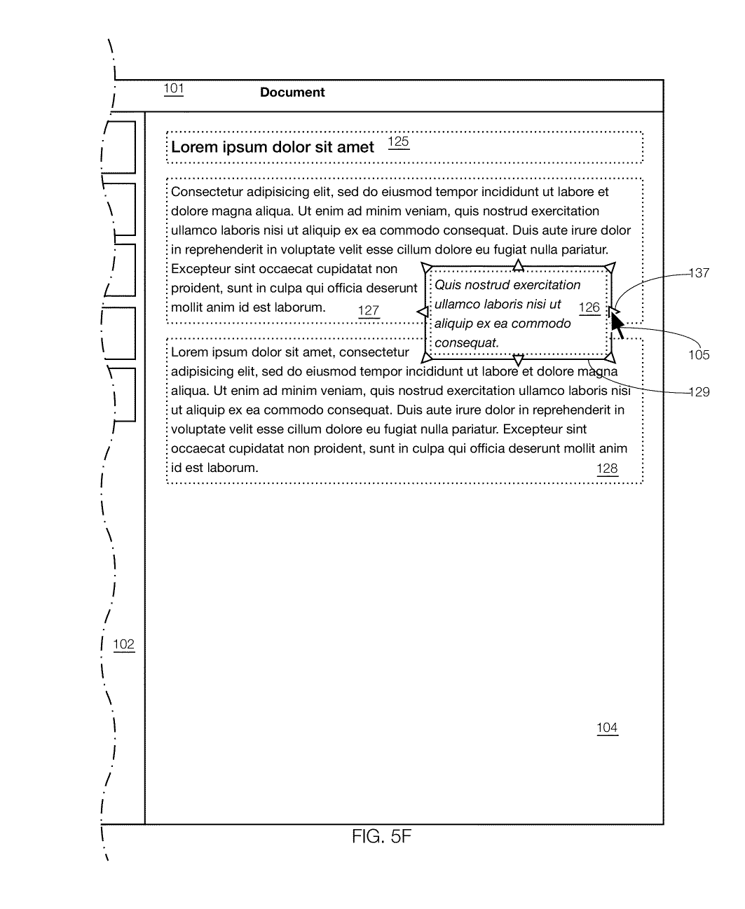

FIG. 5A illustrates an exemplary layout on which the change of margin-values will be exercised. It is important to note that all components of the document are positioned relatively to each other. They are embedded in the normal flow of the HTML document. The header 125 comes before the paragraph 127, while paragraph 128 comes after paragraph 127 and quotation 126 comes before header 125 and has a floating right style set. Absolute positioning of the components is not applied. The order in which elements flow inside a HTML document transports meaning. It represents the flow in which the document is normally read.

As illustrated in FIG. 5B after emphasizing the component subject to the margin modification 126, an indication emphasis 129 will be presented around the component. This indication emphasis 129 represents a selection. It can also indicate the margin editing by adequate means: by specific signs/forms of the drag-handles for example.

The signs/forms of margin modification as shown in FIG. 5B have following meaning: Change top and right margin 130, change top margin only 131, change top and right margin 132, change left margin only 133, change bottom and left margin 134, change bottom margin only 135, change bottom and right margin 136, change right margin only 137.

Other embodiments might contain specific indications of the margin/padding editing mode, or an indication emphasis 129/138/153 (representing the component selection), completely different from the one shown in FIGS. 5B-8D.

As illustrated in FIG. 5C the exemplary modification is made on the top margin of component 126. This modification is performed through a drag-operation of handle 131. In FIG. 5D the result of said drag operation is depicted. By dragging handle 131 down, the top margin of the selected component 126 is modified automatically, moving the selected component congruently with the user interaction 105.

As illustrated in FIG. 5E, performing a drag action to the left on the right handle 137 of the selected component 126, results in modification of its right margin. FIG. 5F shows the outcome of this action.

How a component reacts to margin-changes depends heavily on the applied width and height it may have. An embodiment therefore has to implement appropriate algorithms to achieve a satisfying user interaction and feedback behavior.

The action of visually modifying the component's padding starts by switching into the padding editing mode through a menu item, a shortcut or by pressing a toolbar button. Other embodiments of switching into aforementioned editing mode are possible.

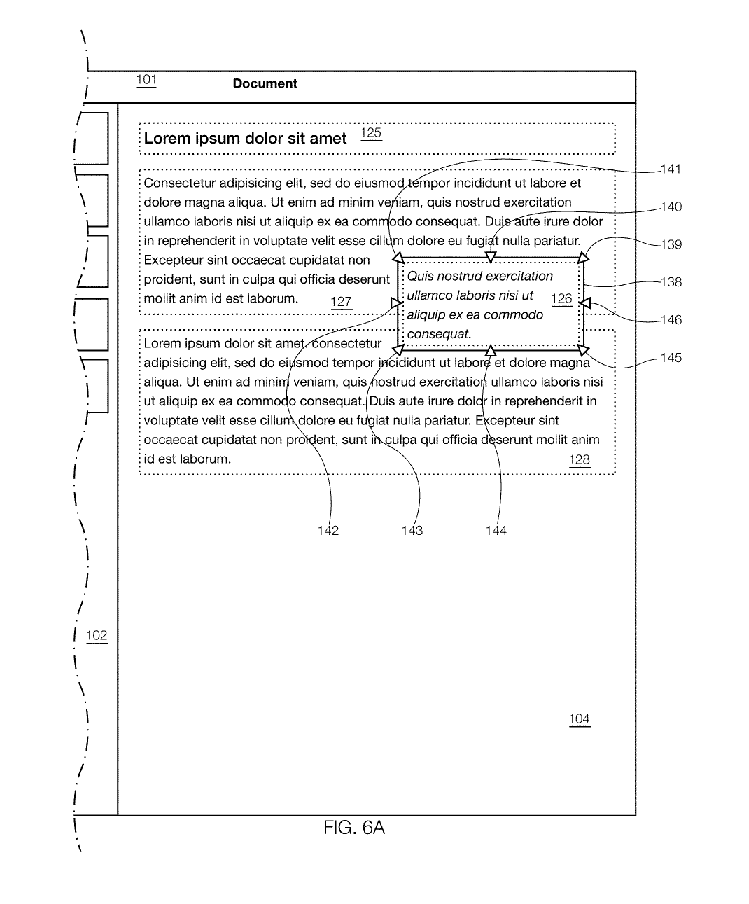

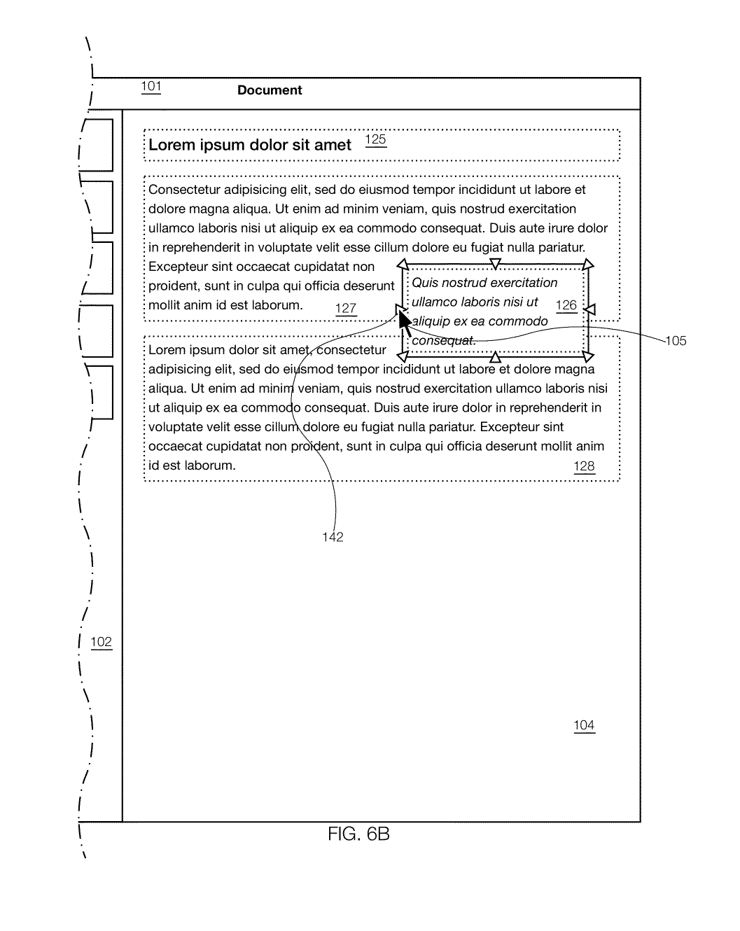

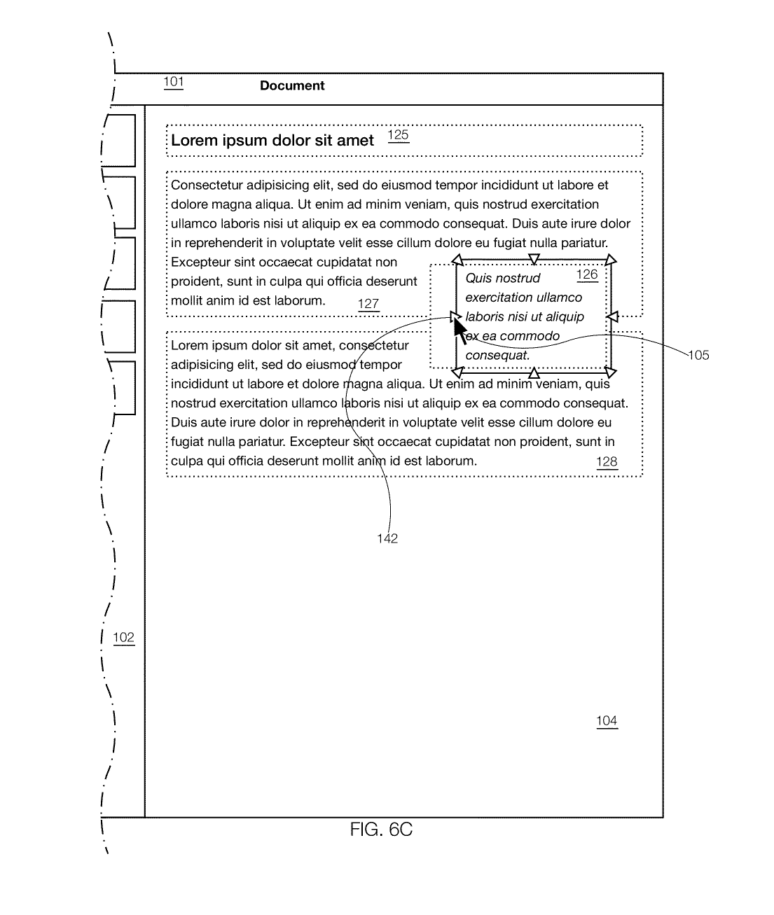

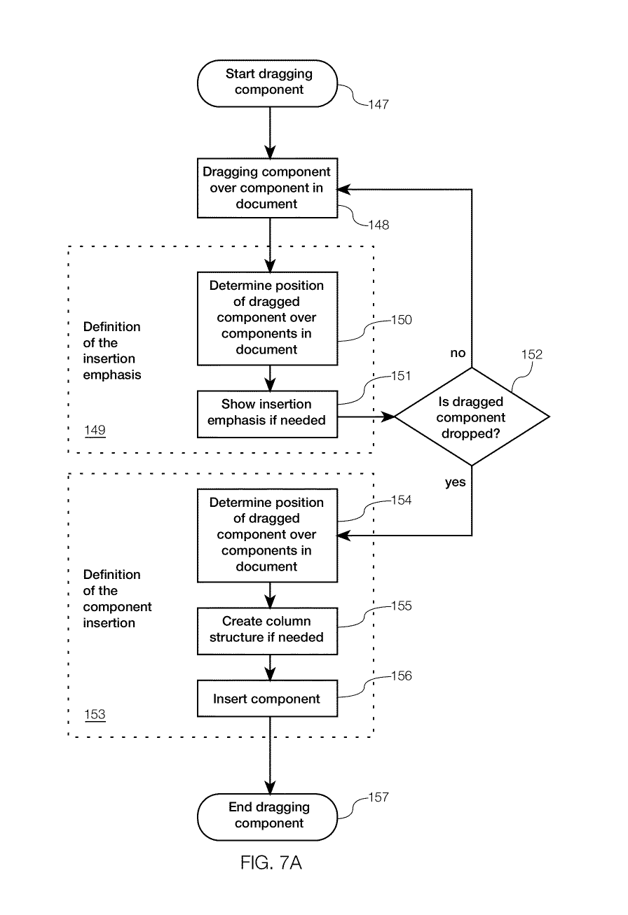

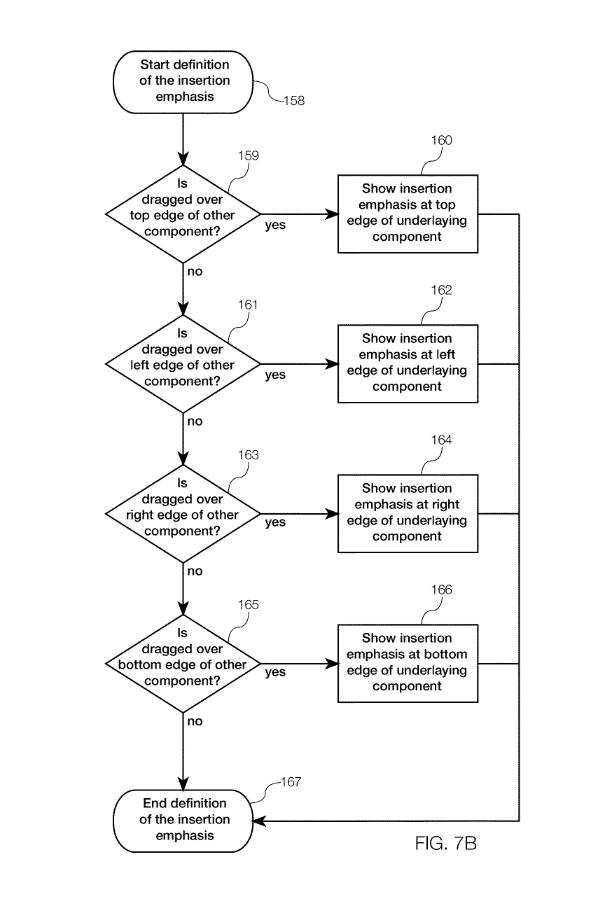

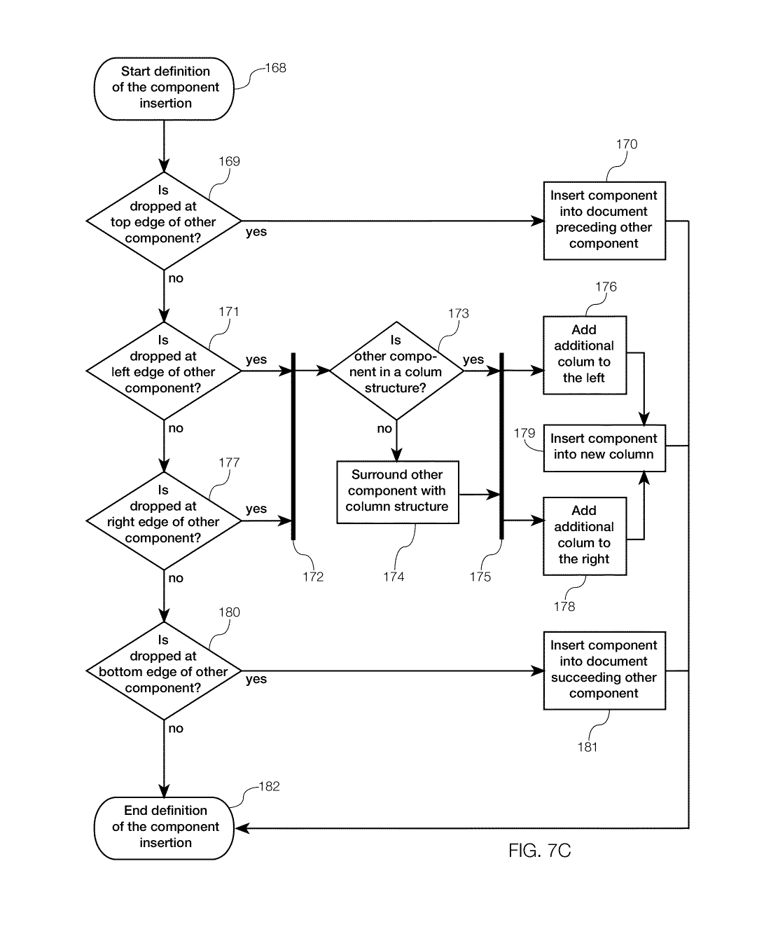

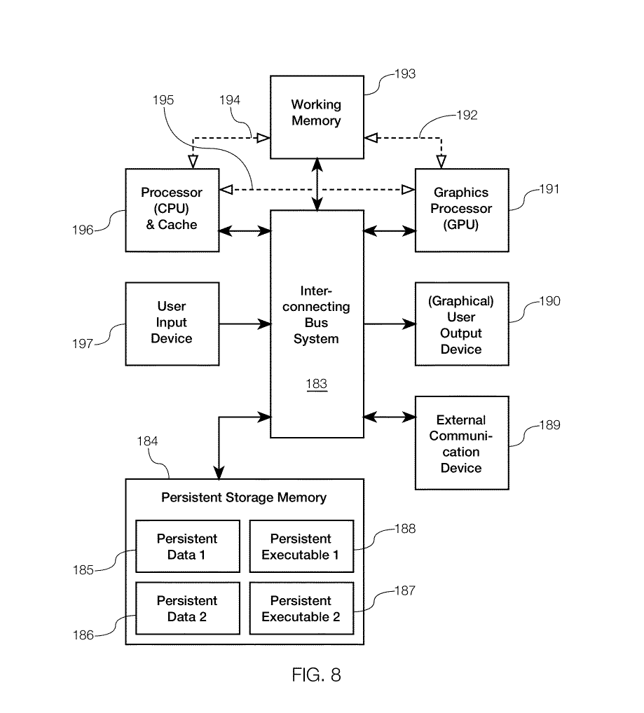

FIG. 6A illustrates an indication emphasis 138 of the selected component 126, in padding editing mode. The meaning of the signs/forms depicted is as follows: Change top and right padding 139, change top padding only 140, change top and right padding 141, change left padding only 142, change bottom and left padding 143, change bottom padding only 144, change bottom and right padding 145, change right padding only 146.

As illustrated in FIG. 6B, the left padding of the selected component 126 is modified by user-interaction 105 with the left handle 142. The result of this action is illustrated in FIG. 6C.

In the illustrations of FIGS. 5A-6C the pointed line surrounds the space occupied by a component. This is solely for the purpose of making the component-borders perceivable. Actual embodiments may or may not include such outlines.

As shown in FIG. 6C modifying the left padding of the selected component 126 has a couple of effects. The left edge of the components 126 content text moves about the value of the padding away from the left border of the component, indicated by the pointed line. Due to the fact that the exemplified component doesn't have a CSS height property set, the content text has less width left over, breaks earlier around line-endings and therefore pushes the components bottom border down. The component therefore gains in height during this specific modification of the left padding. However an actual embodiment may or may not behave the same way.

How a component reacts to padding-changes depends heavily on the applied margins, the width and the height it may have. An embodiment therefore has to implement appropriate algorithms to achieve a satisfying user interaction and feedback behavior.dependent upon the specific HTML/CSS platform behavior intended. The important aspect is the modification of a components padding by direct and interactive means as depicted above.

Advantages of the Present Invention

There are numerous advantages provided by the functionalities described above:

The visual feedback for dragging-and-dropping components of a document allows the user to insert and arrange the components in a responsive column-structure in a flexible and intuitive way, by directly interacting with the components and the column-structure, without the need for additional intermediate configuration-steps concerning the layout of the column-structure. The process of layouting becomes more efficient and fluent.

The time-based method for inserting one component into another makes the interaction more intuitive and efficient. In other comparable applications in the field of web design or print design, for inserting one element into another or for grouping elements, the user normally has to undergo one of the following processes:
1. selecting both elements, selecting a command “group” or applying a keyboard shortcut;
2. selecting an element, double clicking on it for “opening” it, copy-pasting the other element inside of it through a command or a shortcut;
3. just inserting an element into the other by dropping it over it, without the safety of concise indications or operation-separation by time delay.

As it can be seen, the first two cases are more time consuming and require the preparation and knowledge of application-specific commands, while the third method does not provide sufficient feedback that the element is inserted into the other and does not allow sophisticated and precise insert operations inside the element, where for instance a smaller element (like an icon) has to get inserted into a certain position inside a text.

The method for adjusting margins and paddings of a component through direct manipulation solves the same problem of modifying the numeric values of the said CSS elements, but in a more direct, interactive and appealing way. Margins and paddings are CSS properties used very often by the web designers during the layouting process, specific visual manipulation tools therefore empower for a more efficient creation process of website layouts.

All of these functionalities have also a second advantage: the explicit direct interactions depicted in this disclosure teaches the user about the fluid nature of the elements of a HTML document. This is a very important difference with the currently used WYSIWYG web design tools, which are mostly based on layouting paradigms from the designing for print.

Other visual HTML layout tools need to utilize absolute positioning techniques in order to present the well understood visual resizing and repositioning methods and systems, the user knows from traditional layout tools from the DTP-era of designing for prints on paper. This techniques has negative side-effects on a HTML documents inner semantic structure. The semantic structure of an HTML document is important for content-analyzing search-engine-crawlers (like Google's). This entities use a HTML-document's semantics to understand and classify its content.

The present invention's aforementioned modification-techniques try to address this issue by utilizing a combination of methods and systems to present the user with a tooling that almost resembles mentioned well understood visual resizing and repositioning methods and systems from the DTP-era, but without breaking the inner semantic structure and flow order of an HTML document.

The positioning effect is achieved by dragging and dropping components in a system of column-structures, as well as modifying an HTML-elements margin- and padding-values. As a result HTMLs fluid nature of content flow is not negatively affected. The HTML-element in question stays in its semantic context automatically, like if the HTML would be written by hand, concisely optimized for semantics.

As a result, designers are empowered to design for the medium internet without violating the technical constraints imposed by HTML and CSS. Like that the expensive division of labor, expressed in back- and forth-loopings of designs and implementations between developers and designers, can be optimized.

Description of the Computing System

As illustrated in FIG. 8, an exemplary system that implements the technology of the present disclosure, includes a general purpose computing device, consisting of one or more processors for generic 196 or specific 191 purposes, a form of working memory 193, an interconnecting bus system 183, user input 197 and output devices 190, devices for external communication 189 and persistent storage memory units 184.

The processing unit(s) 196 might also contain or be connected to a cache, which represents means of a fast intermediate memory for supporting the operations of a processor 196. One or more processors 196 of the system use one or more caches for keeping data under faster access conditions, than the working memory 193 can provide.

The computing system implementing the present invention can include special purpose processing units like the graphics processor 191 shown in FIG. 8 for illustrative purposes. Several processing units of a kind might be present in an embodiment.

The exemplary working memory 193 represents means for data 185 and executable instructions 188 storage and processing purposes while in frequent need by the processors of the system. Those skilled in the art might add, that this form of memory runs by several names, depending upon their technological details: “Read only memory” (ROM), “random access memory” (RAM) and “graphical random access memory” (Graphics-RAM) are diffused denominations of working memory 193 in embodiments.

The entities, the computing system consists of, are coupled to each other by an interconnecting bus system 183. The purpose of aforementioned bus system is to transport data and execution instructions between the entities of the system.

The working memory 193, of the computing system implementing the present disclosure, can be accompanied by persistent storage memory units 184. Those might not be connected to the system by means of the interconnecting bus system 183 like illustrated in FIG. 8. Connections via the external communication device 189 are imaginable in an embodiment.

The purpose of persistent storage memory 184 is to be used by the computing system to persistently store data and execution instructions, including by not limited to the time periods the computing system is not operational and/or disconnected from a power source.

User input devices 197 represent means of enabling user interactions with the computing device. An embodiment can include any number of mechanisms like mouse, keyboard, drawing pad with a pen, touch-sensitive devices, gesture recognizing devices, speech recognizing subsystems, as well as any sort of motion based input device or any other imaginable technology.

Output of computational results to the user is provided by user output devices 190. To those skilled in the art, many forms of output mechanisms are known, including but not limited to screening, projection and printing technologies. Aforementioned technologies might be visual or tactile in nature.

External communication devices 189 exemplify means for the computing system to communicate with other computing systems, computer-like devices or other technical devices. This includes but not limits to external persistent storage memory 184, that might be connected via a network to the computing system.

The operation of the computing system implementing the present disclosure is performed by copying data 185, 186 and execution instructions (executables) 188, 187 between persistent storage memory 184 and working memory 193. Logical and mathematical computations are encapsulated as mentioned executables (execution instructions) 188, 187 and represent the means in which the processors of the system perform their operations on the data 185, 186. This computations can also incorporate the operations of a number of other entities of the computing system, other computing systems connected via an external communication device or sub-system-entities thereof.

Any of the entities, the computational system consists of, might resemble an own computational system similar to the one described, but in a smaller scale. Furthermore a number of computational systems could be coupled together (via an external communication device 189 or by direct means via an interconnecting bus system 183) to form a larger scale computational system capable to implement the present invention.

The illustrations in FIG. 8 represent exemplary means of integrating the functional entities of a computing system into each other. Any scale of integration between those entities is imaginable, as expressed in the direct interconnects between processor 196 and working memory 193, shown by arrow 194, processor 196 and graphics processor 191, shown by arrow 195, as well as working memory 193 and graphics processor 191, shown by arrow 192. Any other further scale of integration between also the other entities of the system is possible, forming combined entities, representing a functional summary of the entities depicted in FIG. 8 and described herein.

The computing system formed by the miscellaneous entities described above is exemplary and should not limit the scope of the present disclosure. Various mutations of the concept are imaginable and will be recognized by those skilled in the art.

What is claimed is:

1. In a computer system, employing a display, an input device and a graphical user interface, a method for creating web pages, comprising the steps of:
a) displaying a user interface module with a collection of component templates;
b) displaying a graphical presentation area for a document containing markup data, where the user can edit/preview an HTML document; and
c) enabling the user to design the layout of said HTML document by dragging-and-dropping said components with said input device into the column-structure of the document layout;

2. The method of claim 1, wherein the step (c) further comprises the steps of:
a) receiving a selection signal from said input device indicating that a component from said component collection got picked by the user;
b) in response to said selection signal starting to drag said component towards a desired location in said document;
c) receiving a position signal indicating the hovering position of the dragged component over said document;
d) providing a visual feedback which comprises the indication of the possible insertion position atop/below/next-to/between/inside (an)other component(s), already present in said document;
e) receiving a releasing signal from said input device, indicating that the dragged component got dropped; and
f) displaying the rendered dropped component in said document area and adjusting automatically the column-structure according to the position, the dragged component was inserted/dropped at, in relation to other components, by restricting the widths of said components next to each other, forming an adequately sized distribution.

3. The computer system of claim 1, wherein said input device for interacting with said user interface can be a mouse, a touchpad, a drawing pad, a keyboard, a touchscreen or another input device imaginable.

4. The computer system of claim 3, wherein the user can interact with said user interface through the pointer of one of the mentioned input devices or a direct-touch interaction in the case of a touchscreen.

5. The method of claim 1, wherein said components are snippets of HTML code with some CSS stylings applied to them.

6. The method of claim 1, wherein said web site layout is a responsive layout containing a column-structure formed by the rendered markup of said components.

7. The method of claim 1, wherein said column-structure is created and managed according to user-interactions;

8. The method of claim 1, further comprising:
a) enabling the user to insert a component into the rendered markup of another component through a drag-and-drop operation either from said components collection or from another position in said document.

9. The method of claim 8, further comprising the steps of:
a) receiving a position signal indicating the hovering position of the dragged component over the target component;
b) providing visual feedback while the dragged component is hovering over said target component, where said target component is augmented with a sign representing an insertion-region;
c) switching said target component into insertion-mode, represented by an adequate emphasis, after the dragged component is held for a specific amount of time over said insertion region; and
d) receiving the releasing signal from the input device, indicating that the dragged component got dropped into the target component, resulting in rendering the dropped component as markup part of said document.

10. The method of claim 9, wherein the content of said target component comprises text and said insertion-mode of step (c) further comprises the steps of:
a) receiving a position signal indicating the hovering position of the dragged component over the text of the target component;
b) displaying a text insertion caret indicating said insertion position;
c) updating the position of said text insertion caret accordingly to the registered hovering position of the target component; and
d) transmitting the signal of the last registered hovering position to the procedure which stores the position of the dragged component for the retrieval of the insertion position during the drop operation.

11. The method of claim 9, wherein the content of said target component comprises a column structure and said insertion-mode of step (c) further comprises the steps of:
a) receiving a position signal indicating the hovering position of the dragged component over said column structure of the target component;
b) providing a visual feedback which comprises the indication of the possible insertion position atop/below/next-to/between/inside (an)other component(s), already present in said column structure; and
c) transmitting the signal of the last registered hovering position to the procedure which stores the position of the dragged component for the retrieval of the insertion position during the drop operation.

12. The method of claim 1, further comprising:
a) enabling the user to adjust visually and through drag operations with said input device the CSS properties margin and padding of said components;

13. The method of claim 12, further comprising the steps of:
a) enabling the user to switch into the editing mode for margins or paddings through a menu item, a shortcut or by pressing a toolbar button;
b) receiving a dragging signal through said input device, indicating the dragging of specific signs/forms of drag-handles of the component;
c) receiving a position signal indicating the distance from the initial position of said drag-handle to the new position of the drag-handle, resulting in refreshing the values of the margin or the padding of the component; and
d) receiving a releasing signal from said input device, indicating the end of margin/padding adjusting operation, resulting in automatic modifications of margins/paddings congruently with the movement of the user's drag interaction.

14. The method of claim 13, wherein the method of modification depends on the as-is state formed by the margins, paddings, width and height of said component before said modification.

15. A non-transitory computer-readable medium having computer-readable code stored thereon for causing a computer to execute a method comprising the steps of:
a) displaying a user interface module with a collection of component templates;
b) displaying a graphical presentation area for a document containing markup data, where the user can edit/preview an HTML document; and
c) enabling the user to design the layout of said HTML document by dragging-and-dropping said components with said input device into the column-structure of the document layout;

16. The method of claim 15, wherein the step (c) further comprises the steps of:
a) receiving a selection signal from said input device indicating that a component from said component collection got picked by the user;
b) in response to said selection signal starting to drag said component towards a desired location in said document;
c) receiving a position signal indicating the hovering position of the dragged component over said document;
d) providing a visual feedback which comprises the indication of the possible insertion position atop/below/next-to/between/inside (an)other component(s), already present in said document;
e) receiving a releasing signal from said input device, indicating that the dragged component got dropped; and
f) displaying the rendered dropped component in said document area and adjusting automatically the column-structure according to the position, the dragged component was inserted/dropped at, in relation to other components, by restricting the widths of said components next to each other, forming an adequately sized distribution.

17. The non-transitory computer-readable medium of claim 15, wherein said input device for interacting with said user interface can be a mouse, a touchpad, a drawing pad, a keyboard, a touchscreen or another input device imaginable.

18. The non-transitory computer-readable medium of claim 17, wherein the user can interact with said user interface through the pointer of one of the mentioned input devices or a direct-touch interaction in the case of a touchscreen.

19. The non-transitory computer-readable medium of claim 15, wherein said components are snippets of HTML code with some CSS stylings applied to them.

20. The non-transitory computer-readable medium of claim 15, wherein said web site layout is a responsive layout containing a column-structure formed by the rendered markup of said components.

21. The non-transitory computer-readable medium of claim 15, wherein said column-structure is created and managed according to user-interactions;

22. The method of claim 15, further comprising:
a) enabling the user to insert a component into the rendered markup of another component through a drag-and-drop operation either from said components collection or from another position in said document.

23. The method of claim 22, further comprising the steps of:
a) receiving a position signal indicating the hovering position of the dragged component over the target component;
b) providing visual feedback while the dragged component is hovering over said target component, where said target component is augmented with a sign representing an insertion-region;
c) switching said target component into insertion-mode, represented by an adequate emphasis, after the dragged component is held for a specific amount of time over said insertion region; and
d) receiving the releasing signal from the input device, indicating that the dragged component got dropped into the target component, resulting in rendering the dropped component as markup part of said document.

24. The method of claim 23, wherein the content of said target component comprises text and said insertion-mode of step (c) further comprises the steps of:
a) receiving a position signal indicating the hovering position of the dragged component over the text of the target component;
b) displaying a text insertion caret indicating said insertion position;
c) updating the position of said text insertion caret accordingly to the registered hovering position of the target component; and
d) transmitting the signal of the last registered hovering position to the procedure which stores the position of the dragged component for the retrieval of the insertion position during the drop operation.

25. The method of claim 23, wherein the content of said target component comprises a column structure and said insertion-mode of step (c) further comprises the steps of:
a) receiving a position signal indicating the hovering position of the dragged component over said column structure of the target component;
b) providing a visual feedback which comprises the indication of the possible insertion position atop/below/next-to/between/inside (an)other component(s), already present in said column structure; and
c) transmitting the signal of the last registered hovering position to the procedure which stores the position of the dragged component for the retrieval of the insertion position during the drop operation.

26. The method of claim 15, further comprising:
a) enabling the user to adjust visually and through drag operations with said input device the CSS properties margin and padding of said components;

27. The method of claim 26, further comprising the steps of:
a) enabling the user to switch into the editing mode for margins or paddings through a menu item, a shortcut or by pressing a toolbar button;
b) receiving a dragging signal through said input device, indicating the dragging of specific signs/forms of drag-handles of the component;
c) receiving a position signal indicating the distance from the initial position of said drag-handle to the new position of the drag-handle, resulting in refreshing the values of the margin or the padding of the component; and
d) receiving a releasing signal from said input device, indicating the end of margin/padding adjusting operation, resulting in automatic modifications of margins/paddings congruently with the movement of the user's drag interaction.

28. The method of claim 26, wherein the method of modification depends on the as-is state formed by the margins, paddings, width and height of said component before said modification.
